(19) United States
(12) Patent Application Publication
(10) Pub. No.: US 2025/0087091 A1
(43) Pub. Date: Mar. 13, 2025

(54) SYSTEMS AND METHODS FOR DETECTION, ALERTING, AND AVOIDANCE OF ROAD HAZARDS

(71) Applicant: State Farm Mutual Automobile Insurance Company, Bloomington, IL (US)

(72) Inventors: Megan Hucek, Scottsdale, AZ (US); Seth L. Corin, Cumming, GA (US); Craig B. Cope, Bloomington, IL (US)

(21) Appl. No.: 18/771,000

(22) Filed: Jul. 12, 2024

Related U.S. Application Data
(60) Provisional application No. 63/581,376, filed on Sep. 8, 2023.

(51) Int. Cl. G08G 1/16; B60W 30/09; B60W 60/00; G08G 1/0967

(52) U.S. Cl. CPC G08G 1/16; B60W 30/09; B60W 60/0015; G08G 1/096725; G08G 1/096791; B60W 2556/65

(57) ABSTRACT

A computer system is provided and is programmed to: (1) receive sensor data associated with a primary vehicle traveling on a roadway; (2) detect an obstacle in the roadway; (3) determine a vehicular response to react to the obstacle in the roadway; (4) instruct the primary vehicle to execute the vehicular response; and (5) electronically transmit information associated with the obstacle in the roadway to one or more additional vehicles on the roadway.

### CROSS-REFERENCE TO RELATED APPLICATIONS

This application claims priority to U.S. Provisional Patent Application No. 63/581,376, filed Sep. 8, 2023, the entire contents and disclosure of which are hereby incorporated herein by reference in their entirety.

### FIELD OF USE

The present disclosure relates to vehicle-related hazard detection, avoidance, and reporting and, more particularly, to a computer system and method for detecting vehicle-related hazards and informing other vehicles to avoid the detected hazards.

### BACKGROUND

Modern roadways may include many stationary or temporary hazards, such as potholes, debris and/or stopped vehicles in the roadway. Many hazards not only have a chance of damaging a vehicle driving over the hazard, but may also decrease the driver's and passenger's enjoyment of the ride. Furthermore, swerving to avoid the hazard may cause the vehicle to endanger other vehicles on the roadway. However, in many cases, hazards might not be detected by the driver and/or the vehicle itself until it is too late to act. In some cases, the hazard may be blocked from view by other vehicles until the vehicle is almost upon the hazard. Accordingly, it would be desirable to have a system that assists drivers by warning them about upcoming hazards and assist the driver in navigating around the hazard.

Furthermore, because of the urgent circumstances of emergency incidents, many emergency vehicles travel at accelerated speeds (compared to other traffic) and may ignore traffic signals and stop signs to ensure timely arrival to emergency incident locations or related locations, such as hospitals. Such driving practices may cause emergency vehicles to be at elevated risks of collision with other vehicles on the road. Due to such driving practices, many emergency vehicles use visual and auditory alerts, including lights and sirens, when traveling to and from emergency incident locations. Such alerts are used to mitigate the elevated risks of collision.

Despite the use of such alerts, the elevated risk of collision remains a problem. At least partially due to driver distraction or other noises around the nearby vehicles, emergency vehicle alerts may not be noticed by drivers in a timely manner. When drivers fail to notice such alerts, the risk of collision with emergency vehicles may increase.

Accordingly, systems for improving the alerts of approaching emergency vehicles may be useful to mitigate the risk of collisions between emergency vehicles and other vehicles. Conventional techniques may have additional drawbacks, ineffectiveness, inefficiencies, and/or encumbrances as well.

### BRIEF SUMMARY

The present embodiments may relate to systems and methods for detecting, alerting, and reacting to potential hazards or obstacles in a roadway. The systems and methods described herein may be configured to detect a potential hazard or obstacle, and, in response to that detection, taking action to address the potential hazard or obstacle including alerting the primary driver and/or nearby drivers/passengers, or auto-correcting the vehicle of the primary driver and/or the vehicles of the nearby drivers.

A vehicle avoidance monitoring system, as described herein, may include a vehicle avoidance (“VA”) computer device that is in communication with a mobile computer device associated with a user and/or a vehicle controller of the vehicle. The VA computer device may be configured to a) receive sensor data associated with a primary vehicle traveling on a roadway; b) detect an obstacle in the roadway; c) determine a vehicular response to react to the obstacle in the roadway; d) instruct the primary vehicle to execute the vehicular response; and/or e) electronically transmit information associated with the obstacle in the roadway to one or more additional vehicles on the roadway. The one or more additional vehicles may be configured to activate at least one alert action to notify a driver of the corresponding vehicle of the obstacle in the roadway. The one or more additional vehicles may be configured to activate at least one autonomous and/or semi-autonomous control systems in the corresponding vehicle to react to the obstacle in the roadway. The vehicular response includes activating at least one autonomous and/or semi-autonomous control systems in the primary vehicle. The computer system may be a vehicle controller of the primary vehicle. The VA computer device may be further configured to: i) transmit the information associated with the obstacle in the roadway to a cloud-based server, wherein the cloud-based server is configured to notify additional vehicles about the obstacle in the roadway; ii) transmit the information associated with the obstacle in the roadway to the one or more additional vehicles via vehicle-to-vehicle (V2V) wireless communications; and/or iii) transmit at least a portion of the sensor data to the one or more additional vehicles. The sensor data may include internal data associated with items and/or operations located inside the primary vehicle. The sensor data may include external data associated with items and/or operations located outside of the primary vehicle. The VA computer device may be further configured to (i) determine the one or more additional vehicles are positioned within a predetermined distance of the primary vehicle; and/or (ii) determine the predetermined distance of the primary vehicle relative to the other vehicles based upon the speed of the primary vehicle. The VA computer device may include additional, less, or alternate functionality, including that discussed elsewhere herein.

In one aspect, a computer system for detecting, alerting, and reacting to potential hazards or obstacles in a roadway may be provided. The computer system may include at least one processor in communication with at least one memory device. The at least one processor may be programmed to: (a) receive sensor data associated with a primary vehicle traveling on a roadway; (b) detect an obstacle in the roadway; (c) determine a vehicular response to react to the obstacle in the roadway; d) instruct the primary vehicle to execute the vehicular response; and/or (e) electronically transmit information associated with the obstacle in the roadway to one or more additional vehicles on the roadway. The computer system may have additional, less, or alternate functionality, including that discussed elsewhere herein.

In another aspect, a computer-based method for detecting, alerting, and reacting to potential hazards or obstacles in a roadway may be provided. The method may be implemented on a vehicle computer device including at least one processor in communication with at least one memory device. The method may include: (a) receiving sensor data associated with a primary vehicle traveling on a roadway; (b) detecting an obstacle in the roadway; (c) determining a vehicular response to react to the obstacle in the roadway; (d) instructing the primary vehicle to execute the vehicular response; and/or (e) electronically transmitting information associated with the obstacle in the roadway to one or more additional vehicles on the roadway. The method may include additional, less, or alternate actions, including those discussed elsewhere herein.

In a further aspect, a non-transitory computer-readable storage medium having computer-executable instructions embodied thereon may be provided. When executed by a processor coupled to at least memory device, the computer-executable instructions may cause the processor to: (a) receive sensor data associated with a primary vehicle traveling on a roadway; (b) detect an obstacle in the roadway; (c) determine a vehicular response to react to the obstacle in the roadway; (d) instruct the primary vehicle to execute the vehicular response; and/or (e) electronically transmit information associated with the obstacle in the roadway to one or more additional vehicles on the roadway. The computer-executable instructions may direct additional, less, or alternate functionality, including that discussed elsewhere herein.

In one aspect, a computer system for detecting, alerting, and reacting to potential hazards or obstacles in a roadway may be provided. The computer system comprising at least one processor in communication with at least one memory device. The at least one processor may be programmed to: (a) receive sensor data associated with a plurality of roadways; (b) detect an obstacle in a first roadway of the plurality of roadways based upon the sensor data; (c) determine a plurality of vehicles traveling on the first roadway where the obstacle in the first roadway; and/or (d) transmit information about the obstacle to the determined plurality of vehicles. The computer system may have additional, less, or alternate functionality, including that discussed elsewhere herein.

In another aspect, a computer-based method for detecting, alerting, and reacting to potential hazards or obstacles in a roadway may be provided. The method may be implemented on a vehicle computer device including at least one processor in communication with at least one memory device. The method may include: (a) receiving sensor data associated with a plurality of roadways; (b) detecting an obstacle in a first roadway of the plurality of roadways based upon the sensor data; (c) determining a plurality of vehicles traveling on the first roadway where the obstacle in the first roadway; and/or (d) transmitting information about the obstacle to the determined plurality of vehicles. The method may include additional, less, or alternate actions, including those discussed elsewhere herein.

In a further aspect, a non-transitory computer-readable storage medium having computer-executable instructions embodied thereon may be provided. When executed by a processor coupled to at least memory device, the computer-executable instructions may cause the processor to: (a) receive sensor data associated with a plurality of roadways; (b) detect an obstacle in a first roadway of the plurality of roadways based upon the sensor data; (c) determine a plurality of vehicles traveling on the first roadway where the obstacle in the first roadway; and/or (d) transmit information about the obstacle to the determined plurality of vehicles. The computer-executable instructions may direct additional, less, or alternate functionality, including that discussed elsewhere herein.

In one aspect, a computer system for detecting, alerting, and reacting to potential hazards or obstacles in a roadway may be provided. The computer system including at least one processor in communication with at least one memory device. The at least one processor may be programmed to: (a) store a plurality of registration information for a plurality of drivers of a plurality of vehicles; (b) receive sensor data associated with a primary vehicle; (c) determine a current condition of at least one of a driver of the primary vehicle and the primary vehicle based upon the sensor data of the primary vehicle; (d) determine a first driver of a first vehicle of that potentially may assist with the current condition of the at least one of the driver of the primary vehicle and the primary vehicle based upon the plurality of registration information; and/or (e) route the first driver of the first vehicle to the primary vehicle. The computer system may have additional, less, or alternate functionality, including that discussed elsewhere herein.

In another aspect, a computer-based method for detecting, alerting, and reacting to potential hazards or obstacles in a roadway may be provided. The method may be implemented on a vehicle computer device including at least one processor in communication with at least one memory device. The method may include: (a) storing a plurality of registration information for a plurality of drivers of a plurality of vehicles; (b) receiving sensor data associated with a primary vehicle; (c) determining a current condition of at least one of a driver of the primary vehicle and the primary vehicle based upon the sensor data of the primary vehicle; (d) determining a first driver of a first vehicle of that potentially may assist with the current condition of the at least one of the driver of the primary vehicle and the primary vehicle based upon the plurality of registration information; and/or (e) routing the first driver of the first vehicle to the primary vehicle. The method may include additional, less, or alternate actions, including those discussed elsewhere herein.

In a further aspect, a non-transitory computer-readable storage medium having computer-executable instructions embodied thereon may be provided. When executed by a processor coupled to at least memory device, the computer-executable instructions may cause the processor to: (a) store a plurality of registration information for a plurality of drivers of a plurality of vehicles; (b) receive sensor data associated with a primary vehicle; (c) determine a current condition of at least one of a driver of the primary vehicle and the primary vehicle based upon the sensor data of the primary vehicle; (d) determine a first driver of a first vehicle of that potentially may assist with the current condition of the at least one of the driver of the primary vehicle and the primary vehicle based upon the plurality of registration information; and/or (e) route the first driver of the first vehicle to the primary vehicle. The computer-executable instructions may direct additional, less, or alternate functionality, including that discussed elsewhere herein.

Advantages will become more apparent to those skilled in the art from the following description of the preferred embodiments which have been shown and described by way of illustration. As will be realized, the present embodiments may be capable of other and different embodiments, and their details are capable of modification in various respects. Accordingly, the drawings and description are to be regarded as illustrative in nature and not as restrictive.

### BRIEF DESCRIPTION OF THE DRAWINGS

The Figures described below depict various aspects of the systems and methods disclosed therein. It should be understood that each Figure depicts an embodiment of a particular aspect of the disclosed systems and methods, and that each of the Figures is intended to accord with a possible embodiment thereof. Further, wherever possible, the following description refers to the reference numerals included in the following Figures, in which features depicted in multiple Figures are designated with consistent reference numerals.

There are shown in the drawings arrangements which are presently discussed, it being understood, however, that the present embodiments are not limited to the precise arrangements and are instrumentalities shown, wherein:

FIG. 1 illustrates a schematic diagram of an exemplary vehicle.

FIG. 2 illustrates a block diagram of an exemplary driving scenario for the vehicle shown in FIG. 1.

FIG. 3 illustrates a flow chart of an exemplary process for monitoring for and avoiding hazards and obstacles for the vehicle shown in FIG. 1 and the scenario shown in FIG. 2.

FIG. 4 illustrates a simplified block diagram of an exemplary computer system for implementing the process shown in FIG. 1.

FIG. 5 illustrates an exemplary configuration of a client computer device shown in FIG. 4, in accordance with one embodiment of the present disclosure.

FIG. 6 illustrates an exemplary configuration of a server shown in FIG. 4, in accordance with one embodiment of the present disclosure.

FIG. 7 illustrates a flow chart of an exemplary computer-implemented process for detecting, alerting, and reacting to potential hazards or obstacles shown in FIG. 2 in a roadway for the vehicle shown in FIG. 1 and using the system 400 shown in FIG. 4.

FIG. 8 illustrates a flow chart of another exemplary computer-implemented process for detecting, alerting, and reacting to potential hazards or obstacles shown in FIG. 2 in a roadway for the vehicle shown in FIG. 1 and using the system shown in FIG. 4.

FIG. 9 illustrates a flow chart of a further exemplary computer-implemented process for detecting, alerting, and reacting to potential hazards or obstacles shown in FIG. 2 in a roadway for the vehicle shown in FIG. 1 and using the system shown in FIG. 4.

The Figures depict preferred embodiments for purposes of illustration only. One skilled in the art will readily recognize from the following discussion that alternative embodiments of the systems and methods illustrated herein may be employed without departing from the principles of the invention described herein.

### DETAILED DESCRIPTION OF THE DRAWINGS

The present disclosure relates to vehicle-related hazard detection, avoidance, and reporting and, more particularly, to a computer-based system and method for detecting vehicle-related hazards and informing other nearby vehicles to avoid the detected hazards.

The present embodiments may relate to, inter alia, systems and methods for vehicle-related hazard detection, avoidance, and reporting and, after detecting the hazard, one or more of alerting the driver in question and other nearby drivers, and/or auto-correcting the vehicle of the distracted driver or the other vehicles of the nearby drivers. In one exemplary embodiment, the process is performed by a vehicle avoidance (“VA”) computer device, also known as a vehicle avoidance (“VA”) server or VA controller. The VA server may be remote from the vehicle and cloud-based or the VA server (or VA controller) may be located at the vehicle. The VA server provides in car feedback and automation about the hazards on the road detected by the vehicle, other vehicles, and/or infrastructure. In some embodiments, the VA server may adjust various Advance Driving Assistance Systems (ADAS) to act to avoid the detected hazards. In some embodiments, the detected hazard is an emergency vehicle that is nearby the vehicle in question.

The VA server includes a monitoring input (in car cameras, sensors, mobile apps) to determine if a hazard is detected. Examples of vehicle-related hazards include, but are not limited to, objects in the roadway, imperfections in the roadway (e.g., potholes), weather-based hazards (e.g., flooded or avalanche covered roadways), and/or emergency vehicles. The VA server communicates that information to the driver in the car and other drivers on the road within a close proximity. The VA server may provide adjustments to the Advance Driving Assistance Systems (ADAS) to compensate for the hazard by adjusting speed, distance, appropriate lane, and route planning accordingly to enhance the degree of safety and reduce the potential of a collision.

In at least one embodiment, data taken from the monitoring inputs may be sent out to the cloud and redistributed to all drivers in proximity of the hazard identified by their respective GPS locations provided by in car monitoring solutions or the various connected car solutions. Each of the monitoring solutions may send the hazard data to the cloud. AI (artificial intelligence) tools included in or accessible by the VA server may evaluate and rate the hazard threat level. The hazard threat level may result in the appropriate safe action for all cars to perform that have the potential of negative impact coming from the detected hazard (e.g., distracted driver(s) or other hazard). Depending on the threat level, the impacted vehicles will either automatically respond and adjust, or the driver will be given a chance to intervene. In some embodiments, the VA server may suggest rerouting the vehicle to avoid the area of roadway with the hazard.

In the exemplary embodiment, sensor data may be continuously collected from a plurality of sources, which may include, but are not limited to, internal sensors, external sensors, infrastructure sensors, sensors located on other vehicles, and/or from at least one sensor associated with the mobile computer device. In some embodiments, the sensor data may be provided by a plurality of sensors in the vehicle or from other nearby vehicles (with the data communicated back to the VA server or directly to the other vehicles). These may include sensors that detect conditions of the vehicle, such as speed, acceleration, gear, braking, and other conditions related to the operation of vehicle, for example: at least one of a measurement of at least one of speed, direction, rate of acceleration, rate of deceleration, location, position, orientation, and rotation of the vehicle, and a measurement of one or more changes to at least one of speed, direction, rate of acceleration, rate of deceleration, location, position, orientation, and rotation of the vehicle. In some embodiments, the plurality of sensors may detect the presence of the driver and one or more passengers in the vehicle. In these embodiments, a plurality of sensors may detect the presence of fastened seatbelts, the weight in each seat in vehicle, heat signatures, or any other method of detecting information about the driver and passengers in vehicle. Furthermore, cameras/sensors may detect facial features of the driver to determine where the driver is looking and determine the current condition of the driver (tired, alert, distracted, etc.).

In some embodiments, a vehicle controller in the vehicle collects the sensor data from sensors and transmits the sensor data to the VA server. In other embodiments, the user's mobile device transmits its collected sensor data to the VA server. In still other embodiments, the user's mobile device is in communication with the vehicle controller. In these other embodiments, the user's mobile device transmits its collected sensor data to the vehicle controller and the vehicle controller transmits the sensor data from the user's mobile device and from the vehicle's sensors to the VA server. In some cases, the vehicle controller may include or be in communication with the VA server.

The VA server analyzes the sensor data to detect potential vehicle-related hazards in the roadway. In some embodiments, the VA server receives sensor data from infrastructure sensors associated with a roadway (the sensors are integrated into the roadway or road signs or other locations near or on the roadway for monitoring movement and items on the roadway). This may include, but is not limited to, cameras on the roadways, depth sensors, moisture sensors, and/or any other sensor that may provide information about the condition of a roadway and/or about any hazards on said roadway. Based upon the current condition of the potential hazard and the surrounding environment, the VA server determines one or more routes or actions for avoiding the hazard and reports those routes and/or actions to the driver of the vehicle. In some embodiments, the vehicle controller performs the analysis, determination, and reporting. In some further embodiments, the vehicle controller transmits at least a portion of the sensor data about the potential hazard to the VA server.

The VA server may activate one or more autonomous and/or semi-autonomous actions to respond to the distracted driver condition and/or threat level. Examples of autonomous and/or semi-autonomous actions may include, but are not limited to, automatic or semi-automatic steering; automatic or semi-automatic acceleration and/or braking; automatic or semi-automatic blind spot monitoring; automatic or semi-automatic collision warning; adaptive cruise control; and/or automatic or semi-automatic parking assistance.

The VA server and/or the vehicle controller may also notify nearby vehicles of the potential hazard. The VA server may notify the other drivers by transmitting messages to other vehicles that are determined to be near the primary vehicle, such as through GPS (Global Positioning System) positioning. In some embodiments, the VA server may determine nearby vehicles through vehicle-to-vehicle (V2V) wireless communication. In some of these embodiments, the VA server may transmit the warning to the primary vehicle to communicate with the nearby vehicles through their V2V communication.

In at least one embodiment, the vehicle controllers of the nearby vehicles receive the warning messages and alert the drivers of those vehicles to the potential hazard. These warning messages may include, but are not limited to, an audio notification (either a tone or a verbal message), vibrating the steering, vibrating the driver's seat, vibrating one or more pedals, a visual notification on the dashboard, a visual notification on the infotainment panel, and/or a visual notification on a head's up display. These notifications may indicate the direction of the potential hazard. These notifications may also indicate directions to the individual vehicle on how to avoid the hazard. The directions may include, but are not limited to, suggestions of lane changes, warnings that other vehicles may be changing lanes into the vehicle's lane, and/or rerouting instructions. In some further embodiments, the vehicle controller may identify the potential hazard using augmented reality on the windshield in a heads-up display to highlight or otherwise indicate the vehicle, such as with one or more arrows. In some embodiments, the VA server may indicate to the other vehicles when the potential hazard has passed, such as when the hazard has been passed and/or when the emergency vehicle has passed the individual vehicle.

In at least one embodiment, the VA server may transmit notifications to vehicles within a specific distance from the primary vehicle. In some embodiments, the specific distance changes based upon the current traffic conditions. For example, the distance may be greater at higher speeds. In some of these embodiments, the VA server determines the distance based upon the amount of time for the vehicle to reach a similar point. In some additional embodiments, the distance may be greater behind the primary vehicle and less in front of the vehicle. The VA server may also transmit notifications to vehicles in oncoming lanes. For example, on a road with one lane each for two-way traffic, the VA server may transmit potential hazard warnings to on-coming vehicles. While on a divided highway, the VA server might not transmit potential hazard warnings to oncoming traffic.

In at least some embodiments, the VA system may coordinate between different drivers to help provide different services. In these embodiments, the VA system stores a plurality of information about the drivers and their vehicles and uses that information to connect drivers with each other when one is in need of assistance.

In one example, the VA server determines that the driver is having the symptoms of a heart attack or other health issue. The VA server determines that the nearest hospital is far away (e.g., the actual distance exceeds a predefined threshold distance), but determines that an off-duty EMT (registered in system) is in their vehicle nearby. The VA server contacts the off-duty EMT to see if they will help the driver having a health issue. If the off-duty EMT agrees, then the VA server routes the off-duty EMT to the driver having the health issue.

In another example, a driver is having a vehicular difficulty, such as a flat tire and needs assistance. The VA server may determine the nearest mobile roadside assistance vehicle and routes that vehicle to the driver having vehicular difficulty. In a further example, an electric vehicle is low on charge and is not near a charging station. The VA server may determine and locate another nearby electric vehicle with extra charge and requests that the nearby vehicle come to charge the vehicle that is low on charge. If the driver of the second vehicle agrees, the VA server directs the second vehicle to the low charge vehicle, so that they may transfer charge. In some embodiments, the VA server directs both of the vehicles to a safe location for charging, such as a parking lot. In some further embodiments, the VA server transfers funds from an account of the first vehicle to an account of the second vehicle to pay for the charging service.

At least one of the technical problems addressed by this system may include: (i) improving safety on the roads; (ii) improved notification of potentially dangerous conditions while operating a vehicle; (iii) improved speed and efficiency of processing distracted driver notifications; (iv) reduced chance of vehicular accidents; and/or (iv) wider net of notifications of roadway hazard conditions occurring.

The methods and systems described herein may be implemented using computer programming or engineering techniques including computer software, firmware, hardware, or any combination or subset thereof, wherein the technical effects may be achieved by performing at least one of the following steps: a) receive sensor data associated with a primary vehicle traveling on a roadway; b) detect an obstacle in the roadway; c) determine a vehicular response to react to the obstacle in the roadway; d) instruct the primary vehicle to execute the vehicular response; e) electronically transmit information associated with the obstacle in the roadway to one or more additional vehicles on the roadway; f) wherein the one or more additional vehicles are configured to activate at least one alert action to notify a driver of the corresponding vehicle of the obstacle in the roadway; g) wherein the one or more additional vehicles are configured to activate at least one autonomous and/or semi-autonomous control systems in the corresponding vehicle to react to the obstacle in the roadway; h) wherein the vehicular response includes activating at least one autonomous and/or semi-autonomous control systems in the primary vehicle; i) wherein the computer system is a vehicle controller of the primary vehicle; j) transmit the information associated with the obstacle in the roadway to a cloud-based server, wherein the cloud-based server is configured to notify additional vehicles about the obstacle in the roadway; k) transmit the information associated with the obstacle in the roadway to the one or more additional vehicles via vehicle-to-vehicle (V2V) wireless communications; l) transmit at least a portion of the sensor data to the one or more additional vehicles; m) wherein the sensor data includes internal data associated with items and/or operations located inside the primary vehicle, n) wherein the sensor data includes external data associated with items and/or operations located outside of the primary vehicle; o) determine the one or more additional vehicles are positioned within a predetermined distance of the primary vehicle; and/or p) determine the predetermined distance of the primary vehicle relative to the other vehicles based upon the speed of the primary vehicle.

The technical effects may also be achieved by performing at least one of the following steps: a) receive sensor data associated with a plurality of roadways; b) detect an obstacle in a first roadway of the plurality of roadways based upon the sensor data; c) determine a plurality of vehicles traveling on the first roadway where the obstacle in the first roadway; d) transmit information about the obstacle to the determined plurality of vehicles; e) the determined plurality of vehicles are configured to activate at least one alert action to notify a driver of the corresponding vehicle of the obstacle in the first roadway; f) the determined plurality of vehicles are configured to activate at least one autonomous and/or semi-autonomous control systems in the corresponding vehicle to react to the obstacle in the first roadway; g) wherein the information about the obstacle reroutes a travel path of the corresponding vehicle to avoid the obstacle; h) wherein the computer system receives sensor data from a plurality of vehicles traveling on the plurality of roadways; i) receives sensor data from one or more infrastructure sensors associated with the plurality of roadways; j) determine the plurality of vehicles traveling on the first roadway where the obstacle in the first roadway potentially will impact each of the plurality of vehicles based upon travel paths for each of the plurality of vehicles; k) wherein the obstacle is an emergency vehicle; l) determine a route for the emergency vehicle; m) detect a plurality of vehicles along the route for the emergency vehicle; and/or n) transmit instructions to the determined plurality of vehicles to clear a path for the emergency vehicle.

The technical effects may further be achieved by performing at least one of the following steps: a) store a plurality of registration information for a plurality of drivers of a plurality of vehicles; b) receive sensor data associated with a primary vehicle; c) determine a current condition of at least one of a driver of the primary vehicle and the primary vehicle based upon the sensor data of the primary vehicle; d) determine a first driver of a first vehicle of that potentially may assist with the current condition of the at least one of a driver of the primary vehicle and the primary vehicle based upon the plurality of registration information; e) route the first driver of the first vehicle to the primary vehicle; f) wherein the current condition of the driver of the primary vehicle is health related and the first driver is a healthcare provider; g) determine a first distance between the primary vehicle and a nearest healthcare facility; h) determine a second distance between the primary vehicle and the first vehicle; i) route the first vehicle to the primary vehicle based upon a comparison of the first distance and the second distance; j) transmit a request to assist to the first driver; k) route the first driver to the primary vehicle if the first driver approves the request to assist; l) determine a second driver of a second vehicle of that potentially may assist with the current condition of the at least one of a driver of the primary vehicle and the primary vehicle based upon the plurality of registration information if the first driver denies the request to assist; m) wherein the current condition of the primary vehicle is drivability related and the first driver is able to provide assistance; n) route the primary vehicle and the first vehicle to a first location; o) wherein the current condition of the primary vehicle is low charge and the first vehicle is able to provide charging services to the primary vehicle; p) storing a plurality of registration information for a plurality of drivers of a plurality of vehicles; q) receiving sensor data associated with a primary vehicle; r) determining a current condition of at least one of a driver of the primary vehicle and the primary vehicle based upon the sensor data of the primary vehicle; s) determining a first driver of a first vehicle of that potentially may assist with the current condition of the at least one of a driver of the primary vehicle and the primary vehicle based upon the plurality of registration information; and t) routing the first driver of the first vehicle to the primary vehicle.

### Exemplary Vehicle

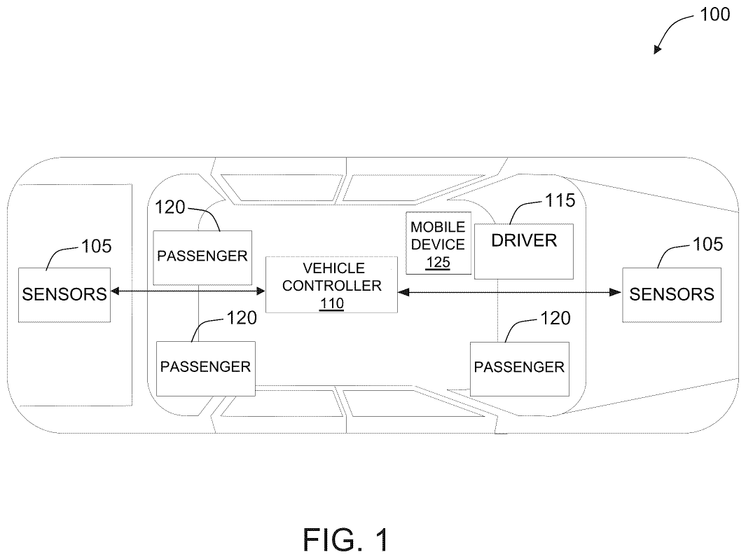

FIG. 1 depicts a view of an exemplary vehicle 100. In some embodiments, vehicle 100 may be an autonomous or semi-autonomous vehicle capable of fulfilling the transportation capabilities of a traditional automobile or other vehicle. In these embodiments, vehicle 100 may be capable of sensing its environment and navigating without human input. In other embodiments, vehicle 100 is a manual vehicle, such as a traditional automobile that is controlled by a driver 115.

Vehicle 100 may include a plurality of sensors 105 and a vehicle controller 110. The plurality of sensors 105 may detect the current surroundings and location of vehicle 100. Plurality of sensors 105 may include, but are not limited to, radar, LIDAR, Global Positioning System (GPS), video devices, imaging devices, cameras, audio recorders, and computer vision. Plurality of sensors 105 may also include sensors that detect conditions of vehicle 100, such as speed, acceleration, gear, braking, and other conditions related to the operation of vehicle 100, for example: at least one of a measurement of at least one of speed, direction rate of acceleration, rate of deceleration, location, position, orientation, and rotation of the vehicle, and a measurement of one or more changes to at least one of speed, direction rate of acceleration, rate of deceleration, location, position, orientation, and rotation of the vehicle. Furthermore, plurality of sensors 105 may include impact sensors that detect impacts to vehicle 100, including force and direction and sensors that detect actions of vehicle 100, such the deployment of airbags. In some embodiments, plurality of sensors 105 may detect the presence of driver 115 and one or more passengers 120 in vehicle 100. In these embodiments, plurality of sensors 105 may detect the presence of fastened seatbelts, the weight in each seat in vehicle 100, heat signatures, or any other method of detecting information about driver 115 and passengers 120 in vehicle 100.

In some embodiments, plurality of sensors 105 may include sensors for determining weight distribution information of vehicle 100. Weight distribution information may include, but is not limited to, the weight and location of remaining gas, luggage, occupants, and/or other components of vehicle 100. In some embodiments, plurality of sensors 105 may include sensors for determining remaining gas, luggage weight, occupant body weight, and/or other weight distribution information. In certain embodiments, plurality of sensors 105 may include occupant position sensors to determine a location and/or position of each occupant (e.g., driver 115 and passengers 120) in vehicle 100. The location of an occupant may identify a particular seat or other location within vehicle 100 where the occupant is located. The position of the occupant may include the occupant's body orientation, the location of specific limbs, and/or other positional information.

In one example, plurality of sensors 105 may include an in-cabin facing camera, LIDAR, radar, weight sensors, accelerometer, gyroscope, compass and/or other types of sensors to identify the location and/or position of occupants within vehicle 100. Vehicle controller 110 and/or another computing device(s) (e.g., mobile device(s)) may be configured to monitor sensor data from plurality of sensors 105 and/or other sensors to determine weight distribution information and/or location and position of the occupants. In one example, vehicle controller 110 may compare sensor data for a particular event (e.g., a road bump) with historical sensor data to identify the weight distribution of vehicle 100 and/or the location of the occupants of vehicle 100. In another example, plurality of sensors 105 may include weight sensors that vehicle controller 110 monitors to determine the weight distribution information.

Vehicle controller 110 may interpret the sensory information to identify appropriate navigation paths, detect threats, and react to conditions. In some embodiments, vehicle controller 110 may be able to communicate with one or more remote computer devices, such as mobile device 125. In the exemplary embodiment, mobile device 125 is associated with driver 115 and includes one or more internal sensors, such as an accelerometer, a gyroscope, and/or a compass. Mobile device 125 may be capable of communicating with vehicle controller 110 wirelessly. In addition, vehicle controller 110 and mobile device may be configured to communicate with computer devices located remotely from vehicle 100. Furthermore, cameras/sensors 105 may detect facial features of the driver 115 to determine where the driver 115 is looking and determine the current condition of the driver 115 (tired, alert, distracted, etc.).

In some embodiments, vehicle 100 may include autonomous or semi-autonomous vehicle-related functionality or technology that may be used with the present embodiments to replace human driver actions may include and/or be related to the following types of functionality: (a) fully autonomous (driverless); (b) limited driver control; (c) vehicle-to-vehicle (V2V) wireless communication; (d) vehicle-to-infrastructure (and/or vice versa) wireless communication; (e) automatic or semi-automatic steering; (f) automatic or semi-automatic acceleration; (g) automatic or semi-automatic braking; (h) automatic or semi-automatic blind spot monitoring; (i) automatic or semi-automatic collision warning; ( ) adaptive cruise control; (k) automatic or semi-automatic parking/parking assistance; (1) automatic or semi-automatic collision preparation (windows roll up, seat adjusts upright, brakes pre-charge, etc.); (m) driver acuity/alertness monitoring; (n) pedestrian detection; (o) autonomous or semi-autonomous backup systems; (p) road mapping systems; (q) software security and anti-hacking measures; (r) theft prevention/automatic return; (s) automatic or semi-automatic driving without occupants; and/or other functionality. In these embodiments, the autonomous or semi-autonomous vehicle-related functionality or technology may be controlled, operated, and/or in communication with vehicle controller 110.

The wireless communication-based autonomous or semi-autonomous vehicle technology or functionality may include and/or be related to: automatic or semi-automatic steering; automatic or semi-automatic acceleration and/or braking; automatic or semi-automatic blind spot monitoring; automatic or semi-automatic collision warning; adaptive cruise control; and/or automatic or semi-automatic parking assistance. Additionally or alternatively, the autonomous or semi-autonomous technology or functionality may include and/or be related to: driver alertness or responsive monitoring; pedestrian detection; artificial intelligence and/or back-up systems; navigation or GPS-related systems; security and/or anti-hacking measures; and/or theft prevention systems.

While vehicle 100 may be an automobile in the exemplary embodiment, in other embodiments, vehicle 100 may be, but is not limited to, other types of ground craft, aircraft, and watercraft vehicles.

### Exemplary Driving Scenario

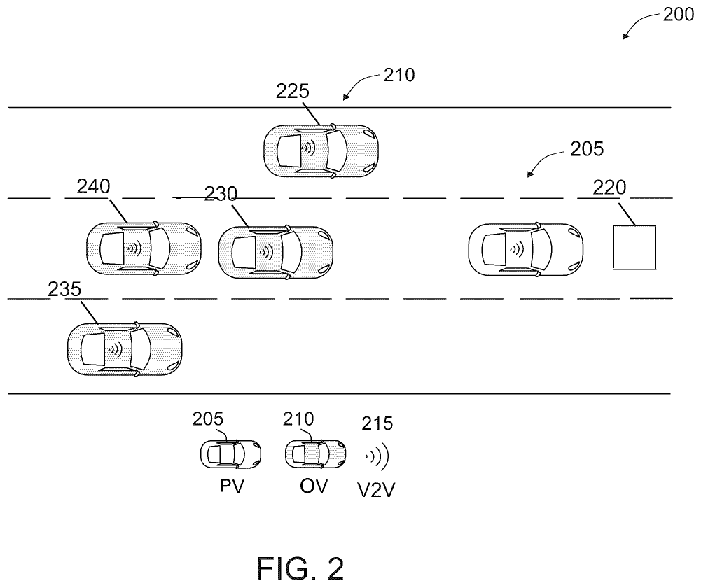

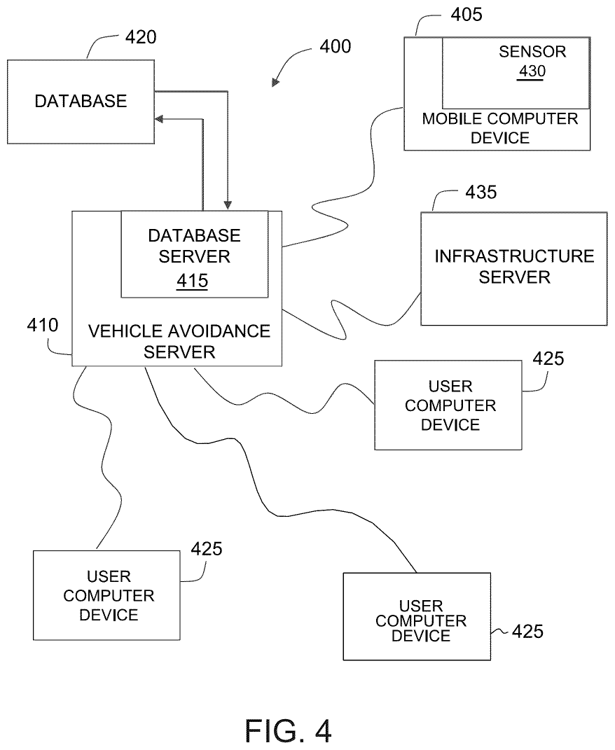

FIG. 2 illustrates a block diagram of a driving scenario 200 for the vehicle shown in FIG. 1. Scenario 200 includes a primary vehicle (PV) 205 in its current lane and other vehicles (OV) 210 in the same lane and/or in nearby lanes. In some embodiments, the PV 205 and OVs 210 may be in communication using V2V communication 215. In some other embodiments, the PV 205 and OV 210 are in communication with VA server 410 (shown in FIG. 4).

In addition, an object 220 (e.g., a hazard) is in the roadway in the same lane as the primary vehicle 205. Furthermore, the other vehicles 210 are labeled OV A 225, OV B 230, OV C 235, and OV D 240 and are in various lanes along the roadway traveling in the same direction as the PV 205 towards the object 220.

### Exemplary Process for Monitoring for Avoiding Hazards and Obstacles

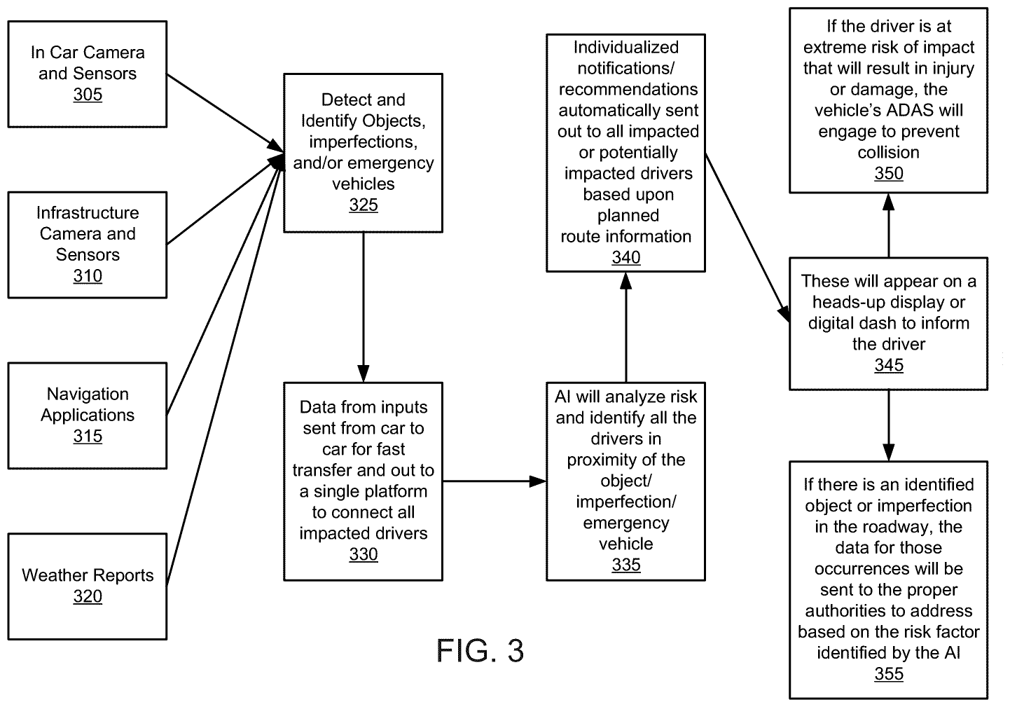

FIG. 3 illustrates a flow chart of an exemplary process 300 for monitoring for and avoiding hazards and obstacles for the vehicle 100 (shown in FIG. 1) and the scenario 200 (shown in FIG. 2). Process 300 may be implemented by a computing device, for example VA server 410 (shown in FIG. 4). In the exemplary embodiment, VA server 410 may be in communication with a mobile computer device 405 (shown in FIG. 4), such as mobile device 125 or vehicle controller 110 (both shown in FIG. 1).

In the exemplary embodiment, in car cameras, sensors 305, external sensors, and/or mobile apps monitor for obstacles 220 (shown in FIG. 2) on the roadway. The in-car cameras and sensors may include sensors 105 (shown in FIG. 1). In the exemplary embodiment, sensor data may be continuously collected from a plurality of sources, which may include, but are not limited to, internal sensors, external sensors, and from at least one sensor associated with the mobile computer device 125 (shown in FIG. 1). In some embodiments, the sensor data may be provided by a plurality of sensors 105 in the primary vehicle 205. These may include sensors 105 that detect conditions of primary vehicle 205, such as speed, acceleration, gear, braking, and other conditions related to the operation of primary vehicle 205, for example: at least one of a measurement of at least one of speed, direction, rate of acceleration, rate of deceleration, location, position, orientation, and rotation of the vehicle, 100 and a measurement of one or more changes to at least one of speed, direction rate of acceleration, rate of deceleration, location, position, orientation, and rotation of the vehicle 100. In some embodiments, the plurality of sensors may detect the presence of driver 115 and one or more passengers 120 in vehicle 100. In these embodiments, the plurality of sensors may detect the presence of fastened seatbelts, the weight in each seat in vehicle 100, heat signatures, or any other method of detecting information about driver 115 and passengers 120 in the vehicle 100. Furthermore, cameras/sensors 105 may detect facial features of the driver 115 to determine where the driver 115 is looking and determine the current condition of the driver 115 (tired, alert, distracted, etc.). In at least one embodiment, the sensor data is also collected from the OVs 210 (shown in FIG. 2) on the roadway.

In the exemplary embodiment, infrastructure cameras and sensors 310 (integrated into the roadway or road signs or other locations near or on the roadway for monitoring movement and items on the roadway) also monitor for obstacles 220 on the roadway. The infrastructure cameras and sensors 310 can detect obstacles 220 in the roadway, slowdown and congestion related to obstacles 220, and other issues that may cause difficulties for vehicles 100. In some embodiments, the infrastructure cameras, and sensors 310 may also detect emergency vehicles on the roadway.

In the exemplary embodiment, navigation applications 315 may also monitor for reports of obstacles 220 on the roadway. The navigation applications 315 may receive reports of obstacles 220 from one or more drivers 115 (shown in FIG. 1). The navigation applications 315 may also detect slowdowns, traffic congestions, and other behavior indicative of an obstacle 220 on the roadway.

In the exemplary embodiment, weather reports 320 may also be collected to detect and/or predict potential issues and/or obstacles 220. For example, the VA server 410 may detect that one or more roads have been flooded from the weather reports 320. The VA server 410 may also determine that one or more roads are extremely dangerous during icy conditions and then report those issues as hazards and/or obstacles 220.

The vehicle controller 110 and/or the VA server 410 collects the data from the in Car Camera and sensors 305, the infrastructure camera and sensors 310, the navigation applications 315, and/or the weather reports 320 to detect and identify 325 objects 220, imperfections, and/or emergency vehicles on the roadway. The vehicle controller 110 and/or the VA server 410 transmits 330 the data from the inputs from vehicle 100 to vehicle 100, such as from PV 205 to OV 210 for fast transfer, such as using the V2V communication 215. The VA server 410 may notify the other drivers 115 by transmitting messages to other vehicles 210 that are determined to be near the primary vehicle 205, such as through GPS (Global Positioning System) positioning. In some embodiments, the VA server 410 may determine nearby vehicles through vehicle-to-vehicle (V2V) wireless communication 215. In some of these embodiments, the VA server 410 may transmit the warning to the primary vehicle 205 to communicate with the nearby vehicles 210 through their V2V communication 215.

The vehicle controller 110 also transmits 330 the data from the inputs to a single platform to connect all drivers 115, such as VA server 410. The vehicle controller 110 and/or the VA server 410 uses artificial intelligence (AI) and machine learning (ML) to analyze 335 risk and identify all of the drivers 115 in proximity to the object/imperfection/emergency vehicle. In some further embodiments, the AI determines one or more risk factors and/or threat levels associated with the hazard.

The AI may determine the threat level based upon the amount of damage that the object 220 and/or hazard may cause to a vehicle 100. The threat level may also identify a current possibility of an accident caused by the object 220 and based on the current environment of the roadway. For example, a spilled box of packing peanuts would likely have a lesser threat level than a metal ladder in the roadway. In the example, the metal ladder has a greater chance of causing serious damage to a vehicle 100 that may hit it. The AI may also determine the threat level based upon how easy it is for drivers to avoid the hazard. An object 220 that covers multiple lanes on a roadway, may have a higher threat level than an object 220 that covers a single lane or portion of a single lane. This threat level may also be based on the speed of traffic on the roadway and/or the visibility conditions on the roadway at that time.

The VA server 410 and/or the vehicle controller 110 generates 340 individualized notifications/recommendations that will be automatically sent out or transmitted to all impacted or potentially impacted drivers based upon planned route information and/or proximity. In the exemplary embodiment, the vehicle controller 110 of the vehicle 100 receiving an individualized notification will cause the individualized notification to appear 345 on a heads-up display or digital dashboard to inform the driver 115. In the exemplary embodiment, the VA server 410 and/or the vehicle controller 110 may activate the individualized action, such as via heads-up display, safety notifications (seats vibrating), or on any of the information screens in the vehicle 100 to each driver 115 directly to minimize injury or accident. Based upon the calculated threat level, the VA server 410 may determine which action to take to notify the driver 115 of the potential hazard. These actions may include, but are not limited to, an audio notification (either a tone or a verbal message), vibrating the steering, vibrating the driver's seat, vibrating one or more pedals, a visual notification on the dashboard, a visual notification on the infotainment panel, and/or a visual notification on a head's up display. In some further embodiments, the vehicle controller 110 may identify the object 220 of the potential hazard using augmented reality to highlight or otherwise indicate the object 220.

In at least one embodiment, the VA server 410 may transmit notifications to vehicles 210 within a specific distance from the primary vehicle 205. In some embodiments, the specific distance changes based upon the current traffic conditions. For example, the threshold distance may be greater at higher speeds. In some of these embodiments, the VA server 410 determines the distance based upon the amount of time for the other vehicle 210 to reach a similar point. In some additional embodiments, the distance may be greater for vehicles 210 behind the primary vehicle 205 and less for vehicles 210 in front of the primary vehicle 205. The VA server 410 may also transmit notifications to vehicles 210 in oncoming lanes. For example, on a road with one lane each for two-way traffic, the VA server 410 may transmit potential hazard warnings to on-coming vehicles. While on a divided highway, the VA server 410 might not transmit potential hazard warnings to oncoming traffic.

The notification is configured to not startle the driver 115 and to prevent causing the driver 115 to lose control of the primary vehicle 205 or the other vehicle 210. In one example embodiment, the VA server 410 may sound a noise, such as a horn, to attract the attention of the occupant and entice the occupant to change their direction of facing, such as towards the sounds.

In some embodiments, such as if the driver 115 is at an extreme risk of impact that may result in injury or damage, the vehicle's ADAS will engage to prevent 350 the collision. If required, the VA server 410 may instruct the vehicle controller 110 to take one or more recommended actions automatically, such as by a vehicle's safety systems to avoid injury or accident. The VA server 410 and/or the vehicle controller 110 may activate one or more autonomous and/or semi-autonomous actions to respond to the distracted driver condition and/or threat level. Examples of autonomous and/or semi-autonomous actions may include, but are not limited to, automatic or semi-automatic steering; automatic or semi-automatic acceleration and/or braking; automatic or semi-automatic blind spot monitoring; automatic or semi-automatic collision warning; adaptive cruise control; and/or automatic or semi-automatic parking assistance.

In some further embodiments, if there is an object 220 or imperfection in the roadway, the data for those occurrences will be sent 355 to the proper authorities to address the issue based upon a risk factor identified by the AI.

In the exemplary embodiment, the VA server 410 collects data from the driver reactions, sensors, and automated response to be recorded and analyzed to improve the future performance of the system.

### Exemplary Computer Network

FIG. 4 depicts a simplified block diagram of an exemplary computer system 400 for implementing process 300 shown in FIG. 3. In the exemplary embodiment, system 400 may be used for monitoring for obstacles and hazards 220 based upon sensor data, alerting the driver about the obstacle/hazard 220, and notifying other drivers in nearby vehicles. As described below in more detail, vehicle avoidance (“VA”) server 410 may be configured to (1) receive sensor data associated with a primary vehicle 205 (shown in FIG. 2); (2) determine a current condition of a driver 115 (shown in FIG. 1) of the primary vehicle 205 based upon the sensor data of the primary vehicle 205; (3) determine a threat level for the primary vehicle 205 based upon the current condition of the driver 115 of the primary vehicle 205 and the sensor data of the primary vehicle 205; (4) activate at least one action in the primary vehicle 205 based upon the threat level for the primary vehicle 205; and/or (5) electronically transmit the threat level of the primary vehicle 205 to one or more additional vehicles 210 (shown in FIG. 2).

In the exemplary embodiment, user computer devices 425 are computers that include a web browser or a software application, which enables user computer devices 425 to access VA server 410 using the Internet or other network. More specifically, user computer devices 425 are communicatively coupled to the Internet through many interfaces including, but not limited to, at least one of a network, such as the Internet, a local area network (LAN), a wide area network (WAN), or an integrated services digital network (ISDN), a dial-up-connection, a digital subscriber line (DSL), a cellular phone connection, and a cable modem. User computer devices 425 may be any device capable of accessing the Internet including, but not limited to, a desktop computer, a laptop computer, a personal digital assistant (PDA), a cellular phone, a smartphone, a tablet, a phablet, wearable electronics, smart watch, smart glasses, VR (virtual reality) headset, AR (augmented reality) glasses, or other web-based connectable equipment or mobile devices. The VA server 410 may be remote from the vehicle 100 and cloud-based or the VA server 410 (or VA controller) may be located at the vehicle 100. In some embodiments, user computer devices 425 are vehicle controllers 110 (shown in FIG. 1) of other vehicles 210 (shown in FIG. 2).

A database server 415 may be communicatively coupled to a database 420 that stores data. In one embodiment, database 420 may include vehicular crash scenarios, sensor data, and/or insurance claim forms. In the exemplary embodiment, database 420 may be stored remotely from VA server 410. In some embodiments, database 420 may be decentralized. In the exemplary embodiment, a user may access database 420 via user computer devices 405 by logging onto VA server 410, as described herein.

VA server 410 may be communicatively coupled with the user computer devices 425. In some embodiments, VA server 410 may be associated with, or is part of a computer network associated with a vehicle manufacturer or an insurance provider, or in communication with the vehicle manufacturer's or the insurance provider's computer network (not shown). In other embodiments, VA server 410 may be associated with a third party and is merely in communication with the vehicle manufacturer's or the insurance provider's computer network.

One or more mobile computer devices 405 may be communicatively coupled with VA server 410 through the Internet or a cellular network. In the exemplary embodiment, mobile computer devices 405 are computers that include a software application, which enables mobile computer devices 405 to access VA server 410 using the Internet or other network. More specifically, mobile computer devices 405 are communicatively coupled to the Internet through many interfaces including, but not limited to, at least one of a network, such as the Internet, a local area network (LAN), a wide area network (WAN), or an integrated services digital network (ISDN), a dial-up-connection, a digital subscriber line (DSL), a cellular phone connection, and a cable modem.

Mobile computer devices 405 may also include one or more sensors 430. Mobile computer devices 405 may be configured to receive data from sensors 430 and transmit sensor data to VA server 410. In some embodiments, mobile computer device 405 may be mobile device 125 associated with one of the occupants of vehicle 100. Mobile computer device 405 may be, but is not limited to, a personal digital assistant (PDA), a cellular phone, a smartphone, a tablet, a phablet, wearable electronics, smart watch, or other web-based connectable equipment or mobile devices that allow them to function as described herein. In other embodiments, mobile computer device 405 is vehicle 100, and more specifically, vehicle controller 110 (shown in FIG. 1). In some of these embodiments, vehicle controller 110 is in communication with a second mobile computer device 405, such as a user computer device 425. In these embodiments, vehicle controller 110 may be configured to receive sensor data from user computer device 425 and transmit the sensor data to VA server 410. In some embodiments, mobile computer device 405 may include the vehicle controller 110 of the primary vehicle 205 (shown in FIG. 2).

In the exemplary embodiment, sensor 430 may be a configured to detect one or more conditions about vehicle 100, such as primary vehicle 205. For example, sensor 430 may be sensor 105 (shown in FIG. 1). In other embodiments, sensor 430 may be configured to detect one or more conditions of one or more occupants of vehicle 100, such as driver 115 and/or passengers 120 (both shown in FIG. 1).

In the exemplary embodiment, infrastructure servers 435 are computers that include a web browser or a software application, which enables infrastructure servers 435 to access VA server 410 using the Internet or other network. More specifically, infrastructure servers 435 are communicatively coupled to the Internet through many interfaces including, but not limited to, at least one of a network, such as the Internet, a local area network (LAN), a wide area network (WAN), or an integrated services digital network (ISDN), a dial-up-connection, a digital subscriber line (DSL), a cellular phone connection, and a cable modem. Infrastructure servers 450 may be any device capable of accessing the Internet including, but not limited to, a desktop computer, a laptop computer, a personal digital assistant (PDA), a cellular phone, a smartphone, a tablet, a phablet, wearable electronics, smart watch, smart glasses or headsets, or other web-based connectable equipment or mobile devices. The infrastructure servers 435 may be remote from the vehicle 100 and/or remote from the VA server 410. In the exemplary embodiment, the infrastructure server 435 provides data from infrastructure cameras and sensors 310 (shown in FIG. 3) (integrated into the roadway or road signs or other locations near or on the roadway for monitoring movement and items on the roadway)

### Exemplary Client Device

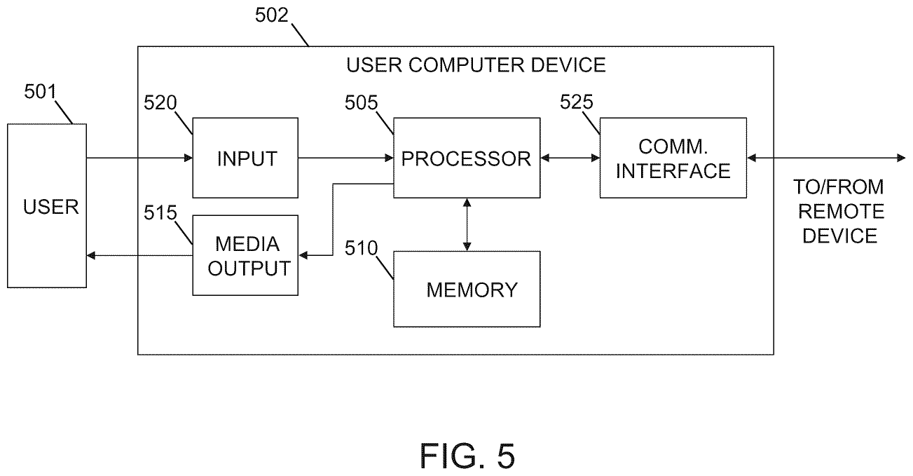

FIG. 5 depicts an exemplary configuration of user computer device 425 shown in FIG. 4, in accordance with one embodiment of the present disclosure. User computer device 502 may be operated by a user 501. User computer device 502 may include, but is not limited to, user computer devices 425 (shown in FIG. 4), mobile computer device 405 (shown in FIG. 4), vehicle controller 110 (shown in FIG. 1), and mobile device 125 (shown in FIG. 1). User computer device 502 may include a processor 505 for executing instructions. In some embodiments, executable instructions are stored in a memory area 510. Processor 505 may include one or more processing units (e.g., in a multi-core configuration). Memory area 510 may be any device allowing information such as executable instructions and/or transaction data to be stored and retrieved. Memory area 510 may include one or more computer readable media.

User computer device 502 may also include at least one media output component 515 for presenting information to user 501. Media output component 515 may be any component capable of conveying information to user 501. In some embodiments, media output component 515 may include an output adapter (not shown) such as a video adapter and/or an audio adapter. An output adapter may be operatively coupled to processor 505 and operatively coupleable to an output device such as a display device (e.g., a cathode ray tube (CRT), liquid crystal display (LCD), light emitting diode (LED) display, or “electronic ink” display) or an audio output device (e.g., a speaker or headphones).

In some embodiments, media output component 515 may be configured to present a graphical user interface (e.g., a web browser and/or a client application) to user 501. A graphical user interface may include, for example, an interface for displaying potential hazards. In some embodiments, user computer device 502 may include an input device 520 for receiving input from user 501. User 501 may use input device 520 to, without limitation, acknowledge the issue notification.

Input device 520 may include, for example, a keyboard, a pointing device, a mouse, a stylus, a touch sensitive panel (e.g., a touch pad or a touch screen), a gyroscope, an accelerometer, a position detector, a biometric input device, and/or an audio input device. A single component such as a touch screen may function as both an output device of media output component 515 and input device 520.

User computer device 502 may also include a communication interface 525, communicatively coupled to a remote device such as VA server 410 (shown in FIG. 4) or vehicle controller 110. Communication interface 525 may include, for example, a wired or wireless network adapter and/or a wireless data transceiver for use with a mobile telecommunications network.

Stored in memory area 510 are, for example, computer readable instructions for providing a user interface to user 501 via media output component 515 and, optionally, receiving and processing input from input device 520. A user interface may include, among other possibilities, a web browser and/or a client application. Web browsers enable users, such as user 501, to display and interact with media and other information typically embedded on a web page or a website from VA server 410. A client application allows user 501 to interact with, for example, VA server 410. For example, instructions may be stored by a cloud service, and the output of the execution of the instructions sent to the media output component 515.

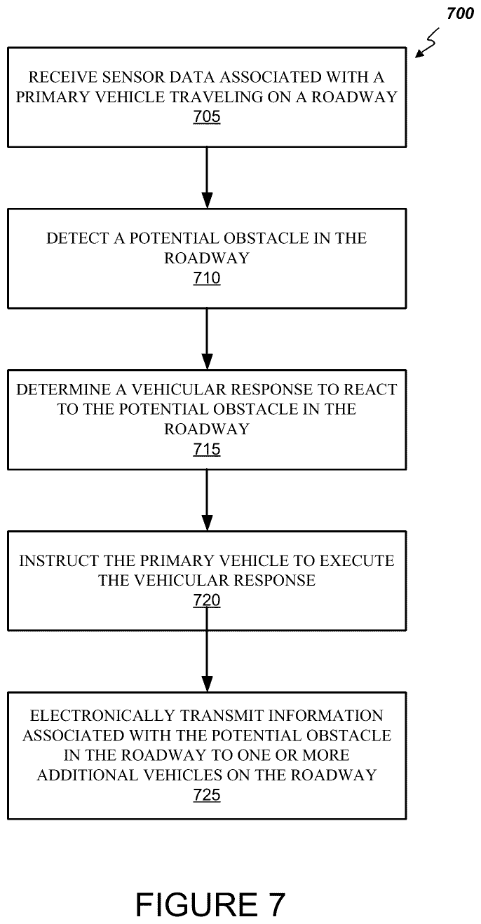

Processor 505 executes computer-executable instructions for implementing aspects of the disclosure. In some embodiments, the processor 505 is transformed into a special purpose microprocessor by executing computer-executable instructions or by otherwise being programmed. For example, the processor 505 may be programmed with the instruction such as illustrated in FIGS. 7-10.

In some embodiments, user computer device 502 may include, or be in communication with, one or more sensors, such as sensor 105 (shown in FIG. 1) and infrastructure sensor 430 (shown in FIG. 4). User computer device 502 may be configured to receive data from the one or more sensors and store the received data in memory area 510. Furthermore, user computer device 502 may be configured to transmit the sensor data to a remote computer device, such as VA server 410, through communication interface 525.

### Exemplary Server Device

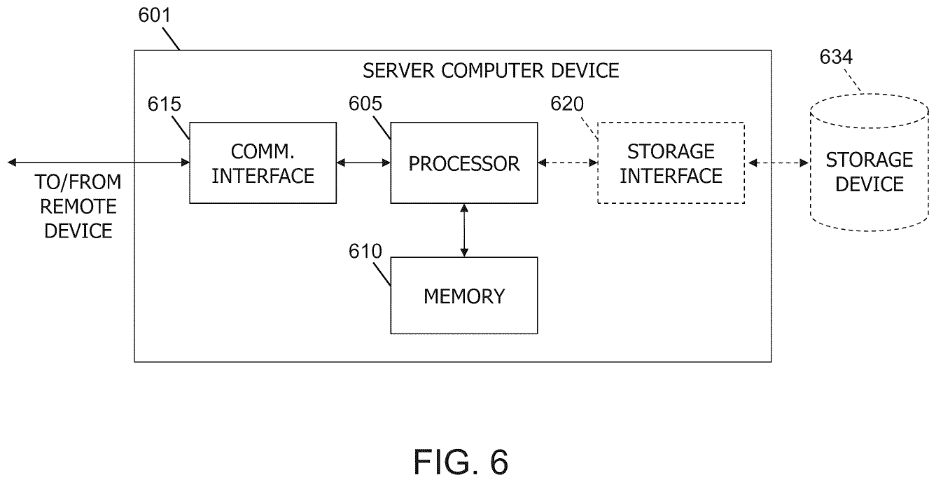

FIG. 6 depicts an exemplary configuration of a server 410 (shown in FIG. 4), in accordance with one embodiment of the present disclosure. Server computer device 601 may include, but is not limited to, database server 415, VA server 410, infrastructure server 435 (all shown in FIG. 4), and vehicle controller 110 (shown in FIG. 1). Server computer device 601 may also include a processor 605 for executing instructions. Instructions may be stored in a memory area 610. Processor 605 may include one or more processing units (e.g., in a multi-core configuration).

Processor 605 may be operatively coupled to a communication interface 615 such that server computer device 601 is capable of communicating with a remote device such as another server computer device 601, mobile device 125 (shown in FIG. 1), mobile computer device 405 (shown in FIG. 4), user computer device 425 (shown in FIG. 4), and VA server 410. For example, communication interface 615 may receive requests from user computer devices 425 via the Internet, as illustrated in FIG. 4.

Processor 605 may also be operatively coupled to a storage device 634. Storage device 634 may be any computer-operated hardware suitable for storing and/or retrieving data, such as, but not limited to, data associated with database 420 (shown in FIG. 4). In some embodiments, storage device 634 may be integrated in server computer device 601. For example, server computer device 601 may include one or more hard disk drives as storage device 634.

In other embodiments, storage device 634 may be external to server computer device 601 and may be accessed by a plurality of server computer devices 601. For example, storage device 634 may include a storage area network (SAN), a network attached storage (NAS) system, and/or multiple storage units such as hard disks and/or solid-state disks in a redundant array of inexpensive disks (RAID) configuration.

In some embodiments, processor 605 may be operatively coupled to storage device 634 via a storage interface 620. Storage interface 620 may be any component capable of providing processor 605 with access to storage device 634. Storage interface 620 may include, for example, an Advanced Technology Attachment (ATA) adapter, a Serial ATA (SATA) adapter, a Small Computer System Interface (SCSI) adapter, a RAID controller, a SAN adapter, a network adapter, and/or any component providing processor 605 with access to storage device 634.

Processor 605 may execute computer-executable instructions for implementing aspects of the disclosure. In some embodiments, the processor 605 may be transformed into a special purpose microprocessor by executing computer-executable instructions or by otherwise being programmed. For example, the processor 605 may be programmed with the instruction such as illustrated in FIGS. 7-10.

### Exemplary Computer-Implemented Method for Detecting, Alerting, & Reacting to Potential Hazards or Obstacles

FIG. 7 illustrates a flow chart of an exemplary computer-implemented process 700 for detecting, alerting, and reacting to potential hazards or obstacles 220 (shown in FIG. 2) in a roadway for the vehicle 100 (shown in FIG. 1) and using the system 400 (shown in FIG. 4) to address such hazards. Process 700 may be implemented by a computing device, for example VA server 410 (shown in FIG. 4) and/or vehicle controller 110 (shown in FIG. 1). In the exemplary embodiment, VA server 410 may be in communication with a mobile computer device 405 (shown in FIG. 4), such as mobile device 125, and/or vehicle controller 110 (both shown in FIG. 1).

In the exemplary embodiment, the VA server 410 may receive 705 sensor data associated with the primary vehicle 205 (shown in FIG. 2) traveling on a roadway.

In the exemplary embodiment, the VA server 410 may detect 710 the obstacle 220 (shown in FIG. 2) in the roadway.

In the exemplary embodiment, the VA server 410 may determine 715 a vehicular response to react to the obstacle 220 in the roadway.

In the exemplary embodiment, the VA server 410 may instruct 720 the primary vehicle 205 to execute the vehicular response.

In the exemplary embodiment, the VA server 410 may electronically transmit 725 information associated with the obstacle in the roadway to one or more additional vehicles 210 (shown in FIG. 2) on the roadway.

In some embodiments, the one or more additional vehicles 210 may be configured to activate at least one alert action to notify a driver 115 of the corresponding vehicle 210 of the obstacle 220 in the roadway.

In some further embodiments, the one or more additional vehicles 210 may be configured to activate at least one autonomous and/or semi-autonomous control systems in the corresponding vehicle 210 to react to the obstacle 220 in the roadway.

In some additional embodiments, the vehicular response may include activating at least one autonomous and/or semi-autonomous control systems in the primary vehicle.

In yet further embodiments, the computer system may be a vehicle controller 110 (shown in FIG. 1) of the primary vehicle 205.

In yet additional embodiments, the VA server 410 may transmit 725 the information associated with the obstacle 220 in the roadway to a cloud-based server 601, configured to notify additional vehicles 210 about the obstacle 220 in the roadway.

In yet additional embodiments, the VA server 410 may transmit 725 the information associated with the obstacle 220 in the roadway to the one or more additional vehicles 210 via vehicle-to-vehicle (V2V) wireless communications 215 (shown in FIG. 2).

In still further embodiments, the sensor data may include internal data associated with items and/or operations located inside the primary vehicle 205. In other embodiments, the sensor data includes external data associated with items and/or operations located outside of the primary vehicle 205.

In still additional embodiments, the VA server 410 may determine the one or more additional vehicles 210 are positioned within a predetermined distance of the primary vehicle 205.

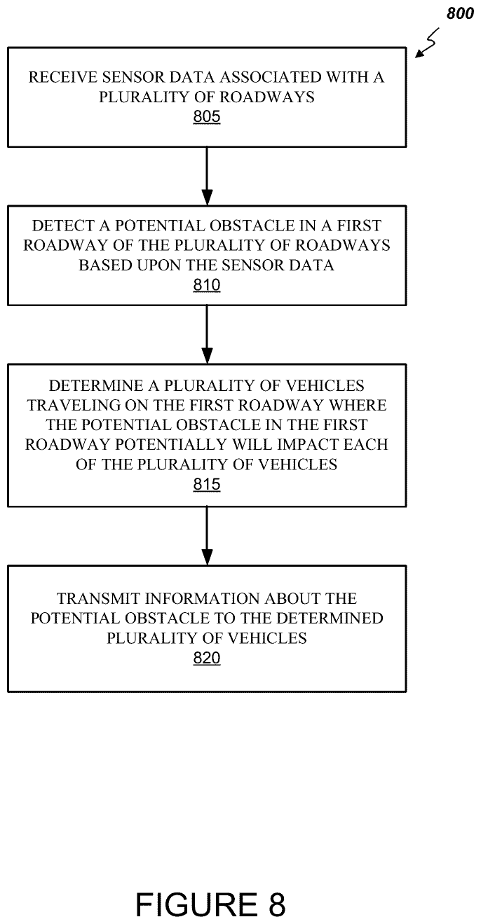

FIG. 8 illustrates a flow chart of another exemplary computer-implemented process 800 for detecting, alerting, and reacting to potential hazards or obstacles 220 (shown in FIG. 2) in a roadway for the vehicle 100 (shown in FIG. 1) and using the system 400 (shown in FIG. 4). Process 800 may be implemented by a computing device, for example VA server 410 (shown in FIG. 4) and/or vehicle controller 110 (shown in FIG. 1). In the exemplary embodiment, VA server 410 may be in communication with a mobile computer device 405 (shown in FIG. 4), such as mobile device 125, and/or vehicle controller 110 (both shown in FIG. 1).

In the exemplary embodiment, the VA server 410 may receive 805 sensor data associated with a plurality of roadways.

In the exemplary embodiment, the VA server 410 may detect 810 the obstacle 220 (shown in FIG. 2) in a first roadway of the plurality of roadways based upon the sensor data.

In the exemplary embodiment, the VA server 410 may determine 815 a plurality of vehicles 210 (shown in FIG. 2) traveling on the first roadway where the obstacle 220 in the first roadway potentially will impact each of the plurality of vehicles 210.

In the exemplary embodiment, the VA server 410 may transmit 820 information about the obstacle 220 to the determined plurality of vehicles 210.

In some embodiments, the determined plurality of vehicles 210 may be configured to activate at least one alert action to notify the driver 115 of the corresponding vehicle 210 of the obstacle 220 in the first roadway.

In further embodiments, the determined plurality of vehicles 210 may be configured to activate at least one autonomous and/or semi-autonomous control systems in the corresponding vehicle 210 to react to the obstacle 220 in the first roadway.

In additional embodiments, the information may be about the obstacle 220. The VA server 410 may reroute a travel path of the corresponding vehicle 210 to avoid the obstacle 220.

In some further embodiments, the VA server 410 may receive sensor data from a plurality of vehicles 210 traveling on the plurality of roadways.

In some additional embodiments, the VA server 410 may receive sensor data from one or more infrastructure sensors associated with the plurality of roadways.

In still further embodiments, the VA server 410 may determine the plurality of vehicles 210 traveling on the first roadway where the obstacle 220 in the first roadway potentially may impact each of the plurality of vehicles 210 based upon travel paths for each of the plurality of vehicles 210.

In still additional embodiments, the obstacle is an emergency vehicle. The VA server 410 may determine a route for the emergency vehicle. The VA server 410 may also detect a plurality of vehicles along the route for the emergency vehicle. The VA server 410 may further transmit instructions to the determined plurality of vehicles to clear a path for the emergency vehicle.

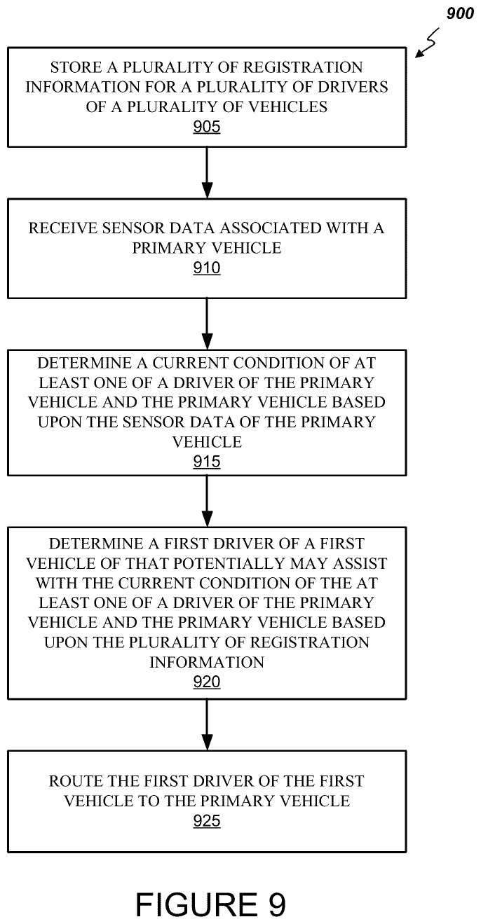

FIG. 9 illustrates a flow chart of a further exemplary computer-implemented process 900 for detecting, alerting, and reacting to potential hazards or obstacles 220 (shown in FIG. 2) in a roadway for the vehicle 100 (shown in FIG. 1) and using the system 400 (shown in FIG. 4). Process 900 may be implemented by a computing device, for example VA server 410 (shown in FIG. 4) and/or vehicle controller 110 (shown in FIG. 1). In the exemplary embodiment, VA server 410 may be in communication with a mobile computer device 405 (shown in FIG. 4), such as mobile device 125, and/or vehicle controller 110 (both shown in FIG. 1).

In the exemplary embodiment, the VA server 410 may store 905 a plurality of registration information for a plurality of drivers 115 (shown in FIG. 1) of a plurality of vehicles 100.

In the exemplary embodiment, the VA server 410 may receive 910 sensor data associated with the primary vehicle 205 (shown in FIG. 2).

In the exemplary embodiment, the VA server 410 may determine 915 a current condition of at least one of the driver 115 of the primary vehicle 205 and the primary vehicle 205 based upon the sensor data of the primary vehicle 205.

In the exemplary embodiment, the VA server 410 may determine 920 that a first driver 115 of a first vehicle 210 may potentially assist with the current condition of the at least one of a driver 115 of the primary vehicle 205 and the primary vehicle 205 based upon the plurality of registration information.

In the exemplary embodiment, the VA server 410 may route 925 the first driver 115 of the first vehicle 210 to the primary vehicle 205.

In some embodiments, the current condition of the driver 115 of the primary vehicle 205 may be health related and the first driver 115 is a healthcare provider. The VA server 410 may determine a first distance between the primary vehicle and a nearest healthcare facility. The VA server 410 may also determine a second distance between the primary vehicle 205 and the first vehicle 210. The VA server 410 may further route the first vehicle 210 to the primary vehicle 205 based upon a comparison of the first distance and the second distance.

In further embodiments, the VA server 410 may transmit a request to assist to the first driver 115. The VA server 410 may also route the first driver 115 to the primary vehicle 205 if the first driver 115 approves the request to assist. The VA server 410 may further determine a second driver 115 of a second vehicle 210 of that potentially may assist with the current condition of the at least one of the driver 115 of the primary vehicle 205 and the primary vehicle 205 based upon the plurality of registration information if the first driver 115 denies the request to assist.

In additional embodiments, the current condition of the primary vehicle 205 may be drivability related and the first driver 115 is able to provide assistance.

In some further embodiments, the VA server 410 may route the primary vehicle 205 and the first vehicle 210 to a first location to meet.

In some additional embodiments, the current condition of the primary vehicle 205 may be low charge and the first vehicle 210 is able to provide charging services to the primary vehicle 205.

### Exemplary Autonomous Feature Selection & Engagement

The one or more processors, sensors, and/or transceivers may be configured or programmed to select an autonomous or semi-autonomous vehicle feature or system to engage based upon (i) the occupant data, (ii) the external data, and/or (iii) the positional information. Additionally or alternatively, the system may be configured to select an autonomous or semi-autonomous vehicle feature or system to engage based upon (1) vehicle weight distribution; and/or (2) occupant skeletal positioning prior to the vehicle collision (as determine from analysis of vehicle-mounted and/or mobile device sensor data, and discussed with respect to FIG. 11). The system may include additional, less, or alternate functionality, including that discussed elsewhere herein.

In another aspect, a computer-based method for detecting a vehicular crash and/or selecting an autonomous or semi-autonomous vehicle feature to engage may be provided. The method may be implemented on a vehicle computer device including one or more processors, sensors, and/or transceivers in communication with at least one memory device. The method may include, via the one or more processors, sensors, and/or transceivers: (1) receiving occupant data from at least one internal sensor; (2) receiving external data from the at least one external sensor; (3) determining, by the vehicle computer device, that a potential vehicular crash is imminent based upon the received external data; and/or (4) automatically engaging an autonomous or semi-autonomous vehicle feature or system to avoid the vehicle collision or otherwise mitigate damage caused by the vehicle collision. The method may further include determining, via the one or more processors, sensors, and/or transceivers, positional information for at least one occupant of a vehicle based upon the occupant data.

The method may include selecting, via the one or more processors, sensors, and/or transceivers, an autonomous or semi-autonomous vehicle feature or system to engage based upon (i) the occupant data, (ii) the external data, (iii) the positional information, and/or other sensor data. For instance, an amount of deceleration or force to apply to the brakes may be determined based upon the (i) occupant data, (ii) external data, and/or (iii) positional information. Additionally or alternatively, the method may include selecting, via the one or more processors, sensors, and/or transceivers, an autonomous or semi-autonomous vehicle feature or system to engage based upon (1) vehicle weight distribution; and/or (2) occupant skeletal positioning prior to the vehicle collision (as determine from analysis of vehicle-mounted and/or mobile device sensor data). The method may include additional, less, or alternate actions, including those discussed elsewhere herein.

The types of autonomous or semi-autonomous vehicle-related functionality or technology that may be used with the present embodiments to replace human driver actions may include and/or be related to the following types of functionality: (a) fully autonomous (driverless); (b) limited driver control; (c) vehicle-to-vehicle (V2V) wireless communication; (d) vehicle-to-infrastructure (and/or vice versa) wireless communication; (e) automatic or semi-automatic steering; (f) automatic or semi-automatic acceleration; (g) automatic or semi-automatic braking; (h) automatic or semi-automatic blind spot monitoring; (i) automatic or semi-automatic collision warning; (j) adaptive cruise control; (k) automatic or semi-automatic parking/parking assistance; (1) automatic or semi-automatic collision preparation (windows roll up, seat adjusts upright, brakes pre-charge, etc.); (m) driver acuity/alertness monitoring; (n) pedestrian detection; (o) autonomous or semi-autonomous backup systems; (p) road mapping systems; (q) software security and anti-hacking measures; (r) theft prevention/automatic return; (s) automatic or semi-automatic driving without occupants; and/or other functionality.

For the method discussed directly above, the wireless communication-based autonomous or semi-autonomous vehicle technology or functionality may include and/or be related to: automatic or semi-automatic steering; automatic or semi-automatic acceleration and/or braking; automatic or semi-automatic blind spot monitoring; automatic or semi-automatic collision warning; adaptive cruise control; and/or automatic or semi-automatic parking assistance. Additionally or alternatively, the autonomous or semi-autonomous technology or functionality may include and/or be related to: driver alertness or responsive monitoring; pedestrian detection; artificial intelligence and/or back-up systems; navigation or GPS-related systems; security and/or anti-hacking measures; and/or theft prevention systems.

### Exemplary Embodiments & Functionality

In one aspect, a computer system for detecting, alerting, and reacting to potential hazards or obstacles in a roadway may be provided. The computer system may include at least one processor in communication with at least one memory device. The at least one processor may be configured or programmed to: (1) receive sensor data associated with a primary vehicle traveling on a roadway; (2) detect an obstacle in the roadway; (3) determine a vehicular response to react to the obstacle in the roadway; (4) instruct the primary vehicle to execute the vehicular response; and/or (5) electronically transmit information associated with the obstacle in the roadway to one or more additional vehicles on the roadway. The computer system may have additional, less, or alternate functionality, including that discussed elsewhere herein.

A further enhancement may be where the one or more additional vehicles may be configured to activate at least one alert action to notify a driver of the corresponding vehicle of the obstacle in the roadway.

A further enhancement may be where the one or more additional vehicles may be configured to activate at least one autonomous and/or semi-autonomous control systems in the corresponding vehicle to react to the obstacle in the roadway.

A further enhancement may be where the vehicular response includes activating at least one autonomous and/or semi-autonomous control systems in the primary vehicle.

A further enhancement may be where the computer system may be a vehicle controller of the primary vehicle.

A further enhancement may be where the computer system transmits the information associated with the obstacle in the roadway to a cloud-based server, wherein the cloud-based server is configured to notify additional vehicles about the obstacle in the roadway.

A further enhancement may be where the computer system transmits the information associated with the obstacle in the roadway to the one or more additional vehicles via vehicle-to-vehicle (V2V) wireless communications.

A further enhancement may be where the computer system transmits at least a portion of the sensor data to the one or more additional vehicles.

A further enhancement may be where the sensor data includes internal data associated with items and/or operations located inside the primary vehicle. A further enhancement may be where the sensor data includes external data associated with items and/or operations located outside of the primary vehicle.

A further enhancement may be where the at least one processor may be further programmed to determine the one or more additional vehicles may be positioned within a predetermined distance of the primary vehicle.

In another aspect, a computer-based method for detecting, alerting, and reacting to potential hazards or obstacles in a roadway may be provided. The method may be implemented on a vehicle computer device including at least one processor in communication with at least one memory device. The method may include: (1) receiving sensor data associated with a primary vehicle traveling on a roadway; (2) detecting an obstacle in the roadway; (3) determining a vehicular response to react to the obstacle in the roadway; (3) instructing the primary vehicle to execute the vehicular response; and/or (4) electronically transmitting information associated with the obstacle in the roadway to one or more additional vehicles on the roadway. The method may include additional, less, or alternate actions, including those discussed elsewhere herein.

A further enhancement may be where the one or more additional vehicles may be configured to activate at least one alert action to notify a driver of the corresponding vehicle of the obstacle in the roadway.

A further enhancement may be where the one or more additional vehicles may be configured to activate at least one autonomous and/or semi-autonomous control systems in the corresponding vehicle to react to the obstacle in the roadway.

A further enhancement may be where the vehicular response includes activating at least one autonomous and/or semi-autonomous control systems in the primary vehicle.

A further enhancement may be where the computer system may be a vehicle controller of the primary vehicle.

A further enhancement may be where the method includes transmitting the information associated with the obstacle in the roadway to a cloud-based server, wherein the cloud-based server is configured to notify additional vehicles about the obstacle in the roadway.

A further enhancement may be where the method includes transmitting the information associated with the obstacle in the roadway to the one or more additional vehicles via vehicle-to-vehicle (V2V) wireless communications.

A further enhancement may be where the method includes transmitting at least a portion of the sensor data to the one or more additional vehicles.

A further enhancement may be where the sensor data includes internal data associated with items and/or operations located inside the primary vehicle. A further enhancement may be where the sensor data includes external data associated with items and/or operations located outside of the primary vehicle.

A further enhancement may be where the method includes determining the one or more additional vehicles may be positioned within a predetermined distance of the primary vehicle.

In a further aspect, a non-transitory computer-readable storage medium having computer-executable instructions embodied thereon may be provided. When executed by a processor coupled to at least memory device, the computer-executable instructions may cause the processor to: (1) receive sensor data associated with a primary vehicle traveling on a roadway; (2) detect an obstacle in the roadway; (3) determine a vehicular response to react to the obstacle in the roadway; (4) instruct the primary vehicle to execute the vehicular response; and/or (5) electronically transmit information associated with the obstacle in the roadway to one or more additional vehicles on the roadway. The computer-executable instructions may direct additional, less, or alternate functionality, including that discussed elsewhere herein.

In one aspect, a computer system for detecting, alerting, and reacting to potential hazards or obstacles in a roadway may be provided. The computer system may include at least one processor in communication with at least one memory device. The at least one processor may be configured or programmed to: (1) receive sensor data associated with a plurality of roadways; (2) detect an obstacle in a first roadway of the plurality of roadways based upon the sensor data; (3) determine a plurality of vehicles traveling on the first roadway where the obstacle in the first roadway; and/or (4) transmit information about the obstacle to the determined plurality of vehicles. The computer system may have additional, less, or alternate functionality, including that discussed elsewhere herein.

A further enhancement may be where the determined plurality of vehicles may be configured to activate at least one alert action to notify a driver of the corresponding vehicle of the obstacle in the first roadway.

A further enhancement may be where the determined plurality of vehicles may be configured to activate at least one autonomous and/or semi-autonomous control systems in the corresponding vehicle to react to the obstacle in the first roadway.

A further enhancement may be where the information about the obstacle reroutes a travel path of the corresponding vehicle to avoid the obstacle.

A further enhancement may be where the computer system receives sensor data from a plurality of vehicles traveling on the plurality of roadways.

A further enhancement may be where the computer system receives sensor data from one or more infrastructure sensors associated with the plurality of roadways.

A further enhancement may be where the computer system transmits the information associated with the obstacle in the roadway to a cloud-based server, wherein the cloud-based server is configured to notify additional vehicles about the obstacle in the roadway.

A further enhancement may be where the computer system determines the plurality of vehicles traveling on the first roadway where the obstacle in the first roadway potentially will impact each of the plurality of vehicles based upon travel paths for each of the plurality of vehicles.

A further enhancement may be where the obstacle may be an emergency vehicle. The computer system may also determine a route for the emergency vehicle. The computer system may further detect a plurality of vehicles along the route for the emergency vehicle. In addition, the computer system may transmit instructions to the determined plurality of vehicles to clear a path for the emergency vehicle.

In another aspect, a computer-based method for detecting, alerting, and reacting to potential hazards or obstacles in a roadway may be provided. The method may be implemented on a vehicle computer device including at least one processor in communication with at least one memory device. The method may include: (1) receiving sensor data associated with a plurality of roadways; (2) detecting an obstacle in a first roadway of the plurality of roadways based upon the sensor data; (3) determining a plurality of vehicles traveling on the first roadway where the obstacle in the first roadway; and/or (4) transmitting information about the obstacle to the determined plurality of vehicles. The method may include additional, less, or alternate actions, including those discussed elsewhere herein.

A further enhancement may be where the determined plurality of vehicles may be configured to activate at least one alert action to notify a driver of the corresponding vehicle of the obstacle in the first roadway.

A further enhancement may be where the determined plurality of vehicles may be configured to activate at least one autonomous and/or semi-autonomous control systems in the corresponding vehicle to react to the obstacle in the first roadway.

A further enhancement may be where the information about the obstacle reroutes a travel path of the corresponding vehicle to avoid the obstacle.

A further enhancement may be where the computer system receives sensor data from a plurality of vehicles traveling on the plurality of roadways.

A further enhancement may be where the computer system receives sensor data from one or more infrastructure sensors associated with the plurality of roadways.

A further enhancement may be where the computer system transmits the information associated with the obstacle in the roadway to a cloud-based server, wherein the cloud-based server is configured to notify additional vehicles about the obstacle in the roadway.

A further enhancement may be where the computer system determines the plurality of vehicles traveling on the first roadway where the obstacle in the first roadway potentially will impact each of the plurality of vehicles based upon travel paths for each of the plurality of vehicles.

A further enhancement may be where the obstacle may be an emergency vehicle. The method may also include determining a route for the emergency vehicle. The method may further include detecting a plurality of vehicles along the route for the emergency vehicle. In addition, the method may include transmitting instructions to the determined plurality of vehicles to clear a path for the emergency vehicle.

In a further aspect, a non-transitory computer-readable storage medium having computer-executable instructions embodied thereon may be provided. When executed by a processor coupled to at least memory device, the computer-executable instructions may cause the processor to: (1) receive sensor data associated with a plurality of roadways; (2) detect an obstacle in a first roadway of the plurality of roadways based upon the sensor data; (3) determine a plurality of vehicles traveling on the first roadway where the obstacle in the first roadway; and/or (4) transmit information about the obstacle to the determined plurality of vehicles. The computer-executable instructions may direct additional, less, or alternate functionality, including that discussed elsewhere herein.

In one aspect, a computer system for detecting, alerting, and reacting to potential hazards or obstacles in a roadway may be provided. The computer system may include at least one processor in communication with at least one memory device. The at least one processor may be configured or programmed to: (1) store a plurality of registration information for a plurality of drivers of a plurality of vehicles; (2) receive sensor data associated with a primary vehicle; (3) determine a current condition of at least one of a driver of the primary vehicle and the primary vehicle based upon the sensor data of the primary vehicle; (4) determine a first driver of a first vehicle of that potentially may assist with the current condition of the at least one of a driver of the primary vehicle and the primary vehicle based upon the plurality of registration information; and/or (5) route the first driver of the first vehicle to the primary vehicle. The computer system may have additional, less, or alternate functionality, including that discussed elsewhere herein.

A further enhancement may be where the current condition of the driver of the primary vehicle is health related and the first driver is a healthcare provider.

A further enhancement may be where the computer system may determine a first distance between the primary vehicle and a nearest healthcare facility. The computer system may also determine a second distance between the primary vehicle and the first vehicle. The computer system may further route the first vehicle to the primary vehicle based upon a comparison of the first distance and the second distance.

A further enhancement may be where the computer system may transmit a request to assist to the first driver. The computer system may also route the first driver to the primary vehicle if the first driver approves the request to assist. The computer system may further determine a second driver of a second vehicle of that potentially may assist with the current condition of the at least one of a driver of the primary vehicle and the primary vehicle based upon the plurality of registration information if the first driver denies the request to assist.

A further enhancement may be where the current condition of the primary vehicle is drivability related and the first driver is able to provide assistance.

A further enhancement may be where the computer system may route the primary vehicle and the first vehicle to a first location.

A further enhancement may be where the current condition of the primary vehicle is low charge, and the first vehicle is able to provide charging services to the primary vehicle.

In another aspect, a computer-based method for detecting, alerting, and reacting to potential hazards or obstacles in a roadway may be provided. The method may be implemented on a vehicle computer device including at least one processor in communication with at least one memory device. The method may include: (1) storing a plurality of registration information for a plurality of drivers of a plurality of vehicles; (2) receiving sensor data associated with a primary vehicle; (3) determining a current condition of at least one of a driver of the primary vehicle and the primary vehicle based upon the sensor data of the primary vehicle; (4) determining a first driver of a first vehicle of that potentially may assist with the current condition of the at least one of a driver of the primary vehicle and the primary vehicle based upon the plurality of registration information; and/or (5) routing the first driver of the first vehicle to the primary vehicle. The method may include additional, less, or alternate actions, including those discussed elsewhere herein.

A further enhancement may be where the one or more additional vehicles are configured to activate at least one alert action to notify a driver of the corresponding vehicle of the obstacle in the roadway.

A further enhancement may be where the one or more additional vehicles are configured to activate at least one autonomous and/or semi-autonomous control systems in the corresponding vehicle to react to the obstacle in the roadway.

A further enhancement may be where the vehicular response includes activating at least one autonomous and/or semi-autonomous control systems in the primary vehicle.

A further enhancement may be where the computer system is a vehicle controller of the primary vehicle.

A further enhancement may be where the method includes transmitting the information associated with the obstacle in the roadway to a cloud-based server, wherein the cloud-based server is configured to notify additional vehicles about the obstacle in the roadway.

A further enhancement may be where the method includes transmitting the information associated with the obstacle in the roadway to the one or more additional vehicles via vehicle-to-vehicle (V2V) wireless communications.

A further enhancement may be where the method includes transmitting at least a portion of the sensor data to the one or more additional vehicles.

A further enhancement may be where the sensor data includes internal data associated with items and/or operations located inside the primary vehicle. A further enhancement may be where the sensor data includes external data associated with items and/or operations located outside of the primary vehicle.

A further enhancement may be where the method includes determining the one or more additional vehicles are positioned within a predetermined distance of the primary vehicle.

In a further aspect, a non-transitory computer-readable storage medium having computer-executable instructions embodied thereon may be provided. When executed by a processor coupled to at least memory device, the computer-executable instructions may cause the processor to: (1) store a plurality of registration information for a plurality of drivers of a plurality of vehicles; (2) receive sensor data associated with a primary vehicle; (3) determine a current condition of at least one of a driver of the primary vehicle and the primary vehicle based upon the sensor data of the primary vehicle; (4) determine a first driver of a first vehicle of that potentially may assist with the current condition of the at least one of a driver of the primary vehicle and the primary vehicle based upon the plurality of registration information; and/or (5) route the first driver of the first vehicle to the primary vehicle. The computer-executable instructions may direct additional, less, or alternate functionality, including that discussed elsewhere herein.

### Machine Learning & Other Matters

The computer-implemented methods discussed herein may include additional, less, or alternate actions, including those discussed elsewhere herein. The methods may be implemented via one or more local or remote processors, transceivers, and/or sensors (such as processors, transceivers, and/or sensors mounted on vehicles or mobile devices, or associated with smart infrastructure or remote servers), and/or via computer-executable instructions stored on non-transitory computer-readable media or medium.

Additionally, the computer systems discussed herein may include additional, less, or alternate functionality, including that discussed elsewhere herein. The computer systems discussed herein may include or be implemented via computer-executable instructions stored on non-transitory computer-readable media or medium.

A processor or a processing element may be trained using supervised or unsupervised machine learning, and the machine learning program may employ a neural network, which may be a convolutional neural network, a deep learning neural network, or a combined learning module or program that learns in two or more fields or areas of interest. Machine learning may involve identifying and recognizing patterns in existing data in order to facilitate making predictions for subsequent data. Models may be created based upon example inputs in order to make valid and reliable predictions for novel inputs.

Additionally or alternatively, the machine learning programs may be trained by inputting sample data sets or certain data into the programs, such as image, mobile device, vehicle telematics, autonomous vehicle, and/or intelligent home telematics data. The machine learning programs may utilize deep learning algorithms that may be primarily focused on pattern recognition and may be trained after processing multiple examples. The machine learning programs may include Bayesian program learning (BPL), voice recognition and synthesis, image or object recognition, optical character recognition, and/or natural language processing—either individually or in combination. The machine learning programs may also include natural language processing, semantic analysis, automatic reasoning, and/or machine learning.

In supervised machine learning, a processing element may be provided with example inputs and their associated outputs and may seek to discover a general rule that maps inputs to outputs, so that when subsequent novel inputs are provided the processing element may, based upon the discovered rule, accurately predict the correct output. In unsupervised machine learning, the processing element may be required to find its own structure in unlabeled example inputs. In one embodiment, machine learning techniques may be used to extract data about the mobile device or vehicle from device details, mobile device sensors, geolocation information, image data, and/or other data.

In some embodiments, generative artificial intelligence (AI) models (also referred to as generative machine learning (ML) models) including voice bots or chatbots may be configured to utilize artificial intelligence and/or machine learning techniques. Data input into the voice bots, chatbots, or other bots may include historical insurance claim data, historical vehicle data, historical sensor information, damage mitigation and prevention techniques, and other data, such as data related to obstacles, vehicles, roads, roadways, determining or identifying obstacles, driver conditions, road conditions, vehicle conditions, etc. The data input into the bot or bots may include text, documents, and images, such as text, documents and images related to vehicles, roads, driver conditions, obstacles, and vehicle damage mitigation and prevention, and sensors. In certain embodiments, a voice or chatbot may be a ChatGPT chatbot. The voice or chatbot may employ supervised or unsupervised machine learning techniques, which may be followed or used in conjunction with reinforced or reinforcement learning techniques. In one aspect, the voice or chatbot may employ the techniques utilized for ChatGPT. The voice bot, chatbot, ChatGPT-based bot, ChatGPT bot, and/or other such generative model may generate audible or verbal output, text or textual output, visual or graphical output, output for use with speakers and/or display screens, vehicle instructions, and/or other types of output for user, smart or autonomous vehicle, and/or other computer or bot consumption.

In one embodiment, a processing element may be trained by providing it with a large sample of phone and/or online credentials with known characteristics or features. Such information may include, for example, fingerprint, device print, verification codes, PBQA, and/or passive voice analysis.

Based upon these analyses, the processing element may learn how to identify characteristics and patterns that may then be applied to analyzing sensor data, authentication data, image data, mobile device data, and/or other data. For example, the processing element may learn, with the user's permission or affirmative consent, to identify the user based upon the user's device or login information. The processing element may also learn how to identify different types of accidents and vehicular crashes based upon differences in the received sensor data. The processing element may further learn how to recreate a vehicular accident based upon partial or incomplete information and determine a level of certainty that the recreation is correct. As a result, at the time of receiving accident data, providing automated reconstruction of a vehicular accident, providing automated population of insurance claim forms, providing automated contact of emergency service personnel, providing information about the vehicular accident prior to the arrival of the emergency service personnel on the scene, providing, and/or providing automated detection of vehicular accidents as they are occurring.

### ADDITIONAL CONSIDERATIONS

The present embodiments may facilitate avoiding vehicle collisions, or otherwise mitigating damage and injuries caused by vehicle collisions. Thus, vehicles configured with the functionality and computer systems may have a lower level of risk than conventional vehicles. Therefore, lower insurance premiums and/or insurance discounts may be generated and provided to insured's owning vehicles configured with the functionality and/or computer systems discussed herein.

As will be appreciated based upon the foregoing specification, the above-described embodiments of the disclosure may be implemented using computer programming or engineering techniques including computer software, firmware, hardware or any combination or subset thereof. Any such resulting program, having computer-readable code means, may be embodied or provided within one or more computer-readable media, thereby making a computer program product, i.e., an article of manufacture, according to the discussed embodiments of the disclosure. The computer-readable media may be, for example, but is not limited to, a fixed (hard) drive, diskette, optical disk, magnetic tape, semiconductor memory such as read-only memory (ROM), and/or any transmitting/receiving medium such as the Internet or other communication network or link. The article of manufacture containing the computer code may be made and/or used by executing the code directly from one medium, by copying the code from one medium to another medium, or by transmitting the code over a network.

These computer programs (also known as programs, software, software applications, “apps,” or code) include machine instructions for a programmable processor and can be implemented in a high-level procedural and/or object-oriented programming language, and/or in assembly/machine language. As used herein, the terms “machine-readable medium” “computer-readable medium” refers to any computer program product, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The “machine-readable medium” and “computer-readable medium,” however, do not include transitory signals. The term “machine-readable signal” refers to any signal used to provide machine instructions and/or data to a programmable processor.

As used herein, the term “database” can refer to either a body of data, a relational database management system (RDBMS), or to both. As used herein, a database can include any collection of data including hierarchical databases, relational databases, flat file databases, object-relational databases, object-oriented databases, and any other structured collection of records or data that is stored in a computer system. The above examples are example only, and thus are not intended to limit in any way the definition and/or meaning of the term database. Examples of RDBMS' include, but are not limited to including, Oracle® Database, MySQL, IBM® DB2, Microsoft® SQL Server, Sybase®, and PostgreSQL. However, any database can be used that enables the systems and methods described herein. (Oracle is a registered trademark of Oracle Corporation, Redwood Shores, California; IBM is a registered trademark of International Business Machines Corporation, Armonk, New York; Microsoft is a registered trademark of Microsoft Corporation, Redmond, Washington; and Sybase is a registered trademark of Sybase, Dublin, California.)

As used herein, a processor may include any programmable system including systems using micro-controllers, reduced instruction set circuits (RISC), application specific integrated circuits (ASICs), logic circuits, and any other circuit or processor capable of executing the functions described herein. The above examples are example only and are thus not intended to limit in any way the definition and/or meaning of the term “processor.”

As used herein, the terms “software” and “firmware” are interchangeable and include any computer program stored in memory for execution by a processor, including RAM memory, ROM memory, EPROM memory, EEPROM memory, and non-volatile RAM (NVRAM) memory. The above memory types are example only and are thus not limiting as to the types of memory usable for storage of a computer program.

In another example, a computer program is provided, and the program is embodied on a computer-readable medium. In an example, the system is executed on a single computer system, without requiring a connection to a server computer. In a further example, the system is being run in a Windows® environment (Windows is a registered trademark of Microsoft Corporation, Redmond, Washington). In yet another example, the system is run on a mainframe environment and a UNIX® server environment (UNIX is a registered trademark of X/Open Company Limited located in Reading, Berkshire, United Kingdom). In a further example, the system is run on an iOS® environment (iOS is a registered trademark of Cisco Systems, Inc. located in San Jose, CA). In yet a further example, the system is run on a Mac OS® environment (Mac OS is a registered trademark of Apple Inc. located in Cupertino, CA). In still yet a further example, the system is run on Android® OS (Android is a registered trademark of Google, Inc. of Mountain View, CA). In another example, the system is run on Linux® OS (Linux is a registered trademark of Linus Torvalds of Boston, MA). The application is flexible and designed to run in various different environments without compromising any major functionality.

In some embodiments, the system includes multiple components distributed among a plurality of computing devices. One or more components may be in the form of computer-executable instructions embodied in a computer-readable medium. The systems and processes are not limited to the specific embodiments described herein. In addition, components of each system and each process can be practiced independent and separate from other components and processes described herein. Each component and process can also be used in combination with other assembly packages and processes.

As used herein, an element or step recited in the singular and proceeded with the word “a” or “an” should be understood as not excluding plural elements or steps, unless such exclusion is explicitly recited. Furthermore, references to “example” or “one example” of the present disclosure are not intended to be interpreted as excluding the existence of additional examples that also incorporate the recited features. Further, to the extent that terms “includes,” “including,” “has,” “contains,” and variants thereof are used herein, such terms are intended to be inclusive in a manner similar to the term “comprises” as an open transition word without precluding any additional or other elements.

Furthermore, as used herein, the term “real-time” refers to at least one of the time of occurrence of the associated events, the time of measurement and collection of predetermined data, the time to process the data, and the time of a system response to the events and the environment. In the examples described herein, these activities and events occur substantially instantaneously.

The patent claims at the end of this document are not intended to be construed under 35 U.S.C. § 112(f) unless traditional means-plus-function language is expressly recited, such as “means for” or “step for” language being expressly recited in the claim(s).

This written description uses examples to disclose the disclosure, including the best mode, and also to enable any person skilled in the art to practice the disclosure, including making and using any devices or systems and performing any incorporated methods. The patentable scope of the disclosure is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

We claim:

1. A computer system comprising at least one processor in communication with at least one memory device, wherein the at least one processor programmed to:
receive sensor data associated with a plurality of roadways;
detect an obstacle in a first roadway of the plurality of roadways based upon the sensor data;
determine a plurality of vehicles traveling on the first roadway toward the obstacle in the first roadway; and
transmit information about the obstacle to the determined plurality of vehicles to help avoid impact of the obstacle.

2. The computer system of claim 1, wherein the determined plurality of vehicles are configured to activate at least one alert action to notify a driver of the corresponding vehicle of the obstacle in the first roadway.

3. The computer system of claim 1, wherein the determined plurality of vehicles are configured to activate at least one autonomous and/or semi-autonomous control system in the corresponding vehicle to react to the obstacle in the first roadway.

4. The computer system of claim 1, wherein the information about the obstacle reroutes a travel path of the corresponding vehicle to avoid the obstacle.

5. The computer system of claim 1, wherein the computer system receives sensor data from a plurality of vehicles traveling on the plurality of roadways.

6. The computer system of claim 1, wherein the computer system receives sensor data from one or more infrastructure sensors associated with the plurality of roadways.

7. The computer system of claim 1, wherein the at least one processor is further programmed to determine the plurality of vehicles traveling on the first roadway where the potential obstacle in the first roadway potentially will impact each of the plurality of vehicles based upon travel paths for each of the plurality of vehicles.

8. The computer system of claim 1, wherein the potential obstacle is an emergency vehicle, and wherein the at least one processor is further programmed to:
determine a route for the emergency vehicle;
detect a plurality of vehicles along the route for the emergency vehicle; and
transmit instructions to the determined plurality of vehicles to clear a path for the emergency vehicle.

9. A computer-based method for implemented on a computer device including at least one processor in communication with at least one memory device, the method comprising:
receiving sensor data associated with a plurality of roadways;
detecting an obstacle in a first roadway of the plurality of roadways based upon the sensor data;
determining a plurality of vehicles traveling on the first roadway where the obstacle in the first roadway; and
transmitting information about the obstacle to the determined plurality of vehicles to help avoid impact of the obstacle.

10. The computer-based method of claim 9, wherein the determined plurality of vehicles are configured to activate at least one alert action to notify a driver of the corresponding vehicle of the obstacle in the first roadway.

11. The computer-based method of claim 9, wherein the determined plurality of vehicles are configured to activate at least one autonomous and/or semi-autonomous control systems in the corresponding vehicle to react to the obstacle in the first roadway.

12. The computer-based method of claim 9, wherein the information about the obstacle reroutes a travel path of the corresponding vehicle to avoid the obstacle.

13. The computer-based method of claim 9, wherein the computer device receives sensor data from a plurality of vehicles traveling on the plurality of roadways.

14. The computer-based method of claim 9, wherein the computer device receives sensor data from one or more infrastructure sensors associated with the plurality of roadways.

15. The computer-based method of claim 9 further comprising determining the plurality of vehicles traveling on the first roadway where the obstacle in the first roadway potentially will impact each of the plurality of vehicles based upon travel paths for each of the plurality of vehicles.

16. The computer-based method of claim 9, wherein the obstacle is an emergency vehicle, and wherein the method further comprises:
determining a route for the emergency vehicle;
detecting a plurality of vehicles along the route for the emergency vehicle; and
transmitting instructions to the determined plurality of vehicles to clear a path for the emergency vehicle.

17. A non-transitory computer-readable storage medium having computer-executable instructions embodied thereon, wherein when executed by a processor coupled to at least memory device, the computer-executable instructions cause the processor to:
receive sensor data associated with a plurality of roadways;
detect an obstacle in a first roadway of the plurality of roadways based upon the sensor data;
determine a plurality of vehicles traveling on the first roadway where the obstacle in the first roadway; and
transmit information about the obstacle to the determined plurality of vehicles to help avoid impact of the obstacle.

18. The transitory computer-readable storage medium of claim 17, wherein the determined plurality of vehicles are configured to activate at least one alert action to notify a driver of the corresponding vehicle of the obstacle in the first roadway.

19. The transitory computer-readable storage medium of claim 17, wherein the determined plurality of vehicles are configured to activate at least one autonomous and/or semi-autonomous control system in the corresponding vehicle to react to the obstacle in the first roadway.

20. The transitory computer-readable storage medium of claim 17, wherein the information about the obstacle reroutes a travel path of the corresponding vehicle to avoid the obstacle.
